(19) United States
(12) Patent Application Publication
(10) Pub. No.: US 2026/0135017 A1
(43) Pub. Date: May 14, 2026

(54) SYSTEMS AND METHODS FOR TRACING COMPOSITE CONDUCTORS

(71) Applicant: TS Conductor Corp., Huntington Beach, CA (US)

(72) Inventors: Chris BLAKEMAN, Rancho Cucamonga, CA (US); Massimo MASINI, Torrance, CA (US)

(21) Appl. No.: 19/381,304

(22) Filed: Nov. 6, 2025

Related U.S. Application Data
(60) Provisional application No. 63/718,002, filed on Nov. 8, 2024.

(51) Int. Cl. H01B 7/36; H01B 7/18; H01B 13/34

(52) U.S. Cl. CPC H01B 7/36; H01B 7/18; H01B 13/34

(57) ABSTRACT

Described herein are methods and apparatuses for traceable electrical conductors, and, in particular, to electrical conductors that include a strength member, including: a core formed of a composite material, an encapsulation layer disposed around the core. A traceability feature is incorporated in at least one of the core or the encapsulation layer. A conductor layer is disposed around the strength member such that the traceability feature is disposed beneath the conductor layer.

### CROSS-REFERENCE TO RELATED APPLICATIONS

The embodiments described herein relate generally to composite conductors for use in grid transmission applications that include traceability features to allow tracing of such conductors in the field. This application claims priority to and the benefit of U.S. Provisional Patent Application No. 63/718,002, filed Nov. 8, 2024, and titled, “SYSTEMS AND METHODS FOR TRACING COMPOSITE CONDUCTORS” the disclosure of which is hereby incorporated by reference herein in its entirety.

### TECHNICAL FIELD

The embodiments described herein relate generally to composite conductors for use in grid transmission applications that include traceability features to allow tracing of such conductors in the field.

### BACKGROUND

The electrical grid is a major contributor to greenhouse emissions and global warming. It is estimated that about 1 billion metric tons of greenhouse gas emissions are released annually and associated with the transport of electricity via the electrical grid. Moreover, most of the existing transmission lines (i.e., conductors or conductor lines) making up the electrical grid are inefficient and antiquated. For example, much of the US electrical grid was built in the 1960s and 1970s, and the US Department of Energy estimates that about 70 percent of existing transmission lines are nearing the end of their 50-year lifecycle. In addition, conventional transmission line conductors, typically using coaxial cables of steel and/or aluminum wires to conduct and transmit electricity through the grid, are plagued by inefficiencies due to high resistive, capacitive, and inductive line losses. It is estimated that about 2,000 TWh of electricity is wasted annually due to such losses in the US alone. These inefficiencies are compounded by harsh operating conditions, such as high operating temperatures, severe weather events, high winds, heavy rains, and prolonged exposure to solar radiation, which may lead to damage of the transmission lines over time (e.g., abrasion, fraying, or breakage of the conductors, moisture invasion into the conductors, oxidation of the metal wires or cables inside the conductors, etc.), increased line losses or inefficiencies, and, eventually, electrical outages upon failure of the transmission line.

Therefore, it would be beneficial to determine the approximate age of an individual portion or section of a transmission line during a routine inspection and/or to track performance of such sections over time. This may, for example, help to establish an estimated time-to-failure for the conductor and/or inform decisions on preventative maintenance activities or pre-failure replacement of poorly performing sections. However, the harsh operating conditions typically reduce visibility of any markings or identifiable features on an outer surface of a conductor, thereby making traceability of individual sections of transmission lines a challenge.

### SUMMARY

Embodiments described herein relate generally to traceable composite conductors, and, in particular, to composite conductors that include a strength member, a conductor layer disposed around the strength member, and traceability features provided on the strength member such that the traceability feature is disposed beneath the conductor layer and substantially protected from the environment by the conductor layer.

In some embodiments, an apparatus includes a strength member, including: a core formed of a composite material, an encapsulation layer disposed around the core, and a traceability feature incorporated in the core and/or the encapsulation layer. In some embodiments, a conductor layer is disposed around the strength member such that the traceability feature is disposed beneath the conductor layer.

In some embodiments, a method includes: disposing an encapsulation layer around a core formed of a composite material to form a strength member; disposing a traceability feature on the strength member; and disposing a conductor layer around the strength member such that the traceability feature is disposed beneath the conductor layer.

In some embodiments, a system includes a conductor including a strength member. The strength member includes a core formed of a composite material and an encapsulation layer disposed around the core. The conductor further includes a conductor layer disposed around at least a portion of the strength member. The system further includes a support assembly coupled to an axial end of the conductor, and a traceability feature coupled to at least one of the conductor or the support assembly.

It should be appreciated that all combinations of the foregoing concepts and additional concepts discussed in greater detail below (provided such concepts are not mutually inconsistent) are contemplated as being part of the inventive subject matter disclose herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic illustration of a conductor for use in grid electrical transmission which includes a traceability feature in the form of a marking, according to an embodiment.

FIG. 2A is a front cross-sectional view of a conductor including an outer coating and a traceability feature, according to an embodiment.

FIG. 2B is a side perspective view of a portion of the conductor of FIG. 2A, with an axial end of a conductor layer removed to show a strength member included therein and a traceability feature incorporated in an encapsulation layer of the strength member, and an axial end portion of the encapsulation layer removed to show an axial end of a core of strength member, according to an embodiment.

FIG. 2C is a front cross-sectional view of the conductor coupled to a support assembly, according to an embodiment.

FIG. 2D is a side view of the conductor of FIG. 2C with a portion of the a conductor layer of the conductor proximate to an axial end of the conductor removed, and a strength member thereof coupled to the support assembly, according to an embodiment.

FIG. 3 is an illustration of a traceability feature, according to an embodiment.

FIG. 4 is an illustration of a spool with a length of a conductor wrapped therearound, and including a tracking device disposed in the spool, according to an embodiment.

FIG. 5 is a schematic flow chart of a method for fabricating a conductor that includes a strength member, a conductor layer, and a traceability feature, according to an embodiment.

FIG. 6 illustrates a plurality of encapsulation layers having traceability features described therein, according to various embodiments.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to traceable composite conductors, and, in particular, to composite conductors that include a strength member, a conductor layer disposed around the strength member, and traceability features provided on the strength member such that the traceability feature is disposed beneath the conductor layer and substantially protected from the environment by the conductor layer.

The electrical grid of the United States is quickly becoming outdated, and major portions of the grid will require replacement in the near future. For example, the American Society of Civil Engineers reported that an estimated 70% of transmission and distribution lines are well into the second half of their 50-year life expectancy, and some lower voltage components are even over 100 years old. Meanwhile, PJM, a regional electrical transmission organization, reported that nearly two-thirds of all bulk electric system assets on their grid are more than 40 years old while more than one third of their transmission assets are more than 50 years old. Likewise, the Western Area Power Administration and the Southwestern Power Administration built the foundation of the electrical grid in the Central U.S. in the 1940s and 1950s.

As described herein, these aging conventional transmission line conductors, typically using coaxial cables of steel and/or aluminum wires to conduct and transmit electricity through the grid, are plagued by inefficiencies due to high resistive, capacitive, and inductive line losses. For example, conventional conductors with steel cores are heavy and have high thermal expansion and thermal sag, which compounds these losses. Alternatively, more modern conductors with Invar cores are expensive and have limited use cases due to their poor tensile strength and high impedance. Similarly, existing composite reinforced conductors, such as aluminum conductors with ceramic reinforcement or carbon fiber composite core conductors, are expensive or difficult to manufacture and vulnerable to bending failures due to poor tensile or compressive strength. Such conventional conductor technologies, which are currently employed in the U.S. for commercial energy distribution, are estimated to waste about 2,000 TWh of electricity due to the resistive, capacitive, and inductive losses during transmission.

Another issue with conventional conductors is the difficulty associated with maintaining traceability of the conductors once installed in the field. Conventional conductors are often either unmarked or include markings for identification or tracing of the conductors on outer surfaces thereof. Such conductors generally fail to retain markings in the field, for example, on their outer surfaces, for the duration of their service life. This may be due to a variety of factors such as, for example, thin wire casings which only allow for shallow surface-level markings or shallow engravings, mechanical, physical, or chemical degradation of the conductor (e.g., due to extended exposure to harsh environmental conditions, solar radiation, high operating temperatures, rain, ice, and/or moisture) that can lead to oxidation or corrosion of the conductor, and/or abrasion due to sand or particulate matter that may be blown across the surface of such conventional conductors during high wind conditions. Therefore, it is challenging to track a conductor at any point during its service life after installation. This leads to difficulties such as locating a specific conductor, identifying a conductor nearing the end of its lifecycle, tracing a particular conductor back to a work order or an installation date and/or evaluating conductor life span and performance in a transmission line. Moreover, such conductors generally do not include any features for determining or tracking the environmental conditions that the conductor may have experienced or been exposed to in the field, such as, for example, moisture or temperature conditions.

Meanwhile, regulators and legislators across the country are establishing mandates to accelerate a transition to renewable energy generation in response to climate change. The U.S. government has also set a goal of zero-carbon electricity by 2035, and a zero-carbon economy by 2050. Accordingly, decarbonization and clean energy procurement targets set by states, utilities, and corporations in the not-so-distant future will require an increase in energy capacity to be quickly and efficiently integrated into the power grid. The influx of energy capacity will necessitate a corresponding increase in transmission capacity to alleviate or prevent congestion and fix reliability issues that may arise as a result. While new, large-scale transmission infrastructure will be a key component to assist in this clean energy transition, regulatory and planning obstacles often get in the way of implementation, and conventional conductor technologies will likely not provide the current-carrying capacity (i.e., ampacity) needed to meet the increased energy demands due to their inherent losses. Therefore, improving the current grid infrastructure may be a more efficient solution for providing more electrical transmission while reducing transmission losses. This may be accomplished, for example, by replacing conventional conductors nearing the end of their service life with lighter, stronger, and higher ampacity conductors that can be easily integrated into the grid while enabling traceability of each individual conductor and analysis of operating parameters or performance over its entire service life (e.g., operating temperature, sag, tension load, etc.).

Accordingly, in contrast to conventional conductors, embodiments of the apparatuses and methods described herein, which may include a strength member having a composite core and an encapsulation layer, a traceability feature incorporated in the strength member, and a conductor layer disposed around the strength member, may provide one or more benefits including, for example: 1) providing a strength member that has a gap free encapsulation layer around a composite core that inhibits presence of air, oxygen, and/or electrolytes at the interface between the encapsulation layer and the core, thereby protecting the encapsulation layer and core interface from corrosion, and the core from oxidation, moisture plasticization, ultraviolet (“UV”) light, corrosion, and environmental degradation; 2) providing a traceability feature in a strength member of the conductor that is disposed within a conductor layer such that the conductor layer inhibits presence of air, oxygen, and/or electrolytes at the interface between the conductor layer and the strength member, thereby protecting the strength member and traceability feature from oxidation, moisture plasticization, UV light, corrosion, and environmental degradation; 3) providing traceability for the conductor throughout its service life, e.g., after being installed in the field; 4) preventing theft or unauthorized use of the conductor because the traceability feature by covertly disposing the traceability feature beneath the conductor layer of the strength member, such that the traceability feature remains hidden from an unauthorized user; 5) allowing evaluation of conditions that the conductor may have been exposed to, for example, exposure to moisture or temperature variations; 6) allowing determination of a lifespan or a service life of the conductor; 7) reducing environmental waste of conductors unnecessarily replaced prior to the expiration of their service life; 8) predicting when conductors may need to be replaced; 9) reducing manhours spent unnecessarily replacing conductors which have not yet met their service life; 10) allowing for traceability of the conductor back to an original purchase order, date of purchase, work order, or installation date; 11) identifying the traceability feature of a conductor through the conductor layer while in service or operation by using radiative energy having a wavelength configured to penetrate through the conductor layer to the traceability feature; and/or 12) non-destructive identification of the conductor.

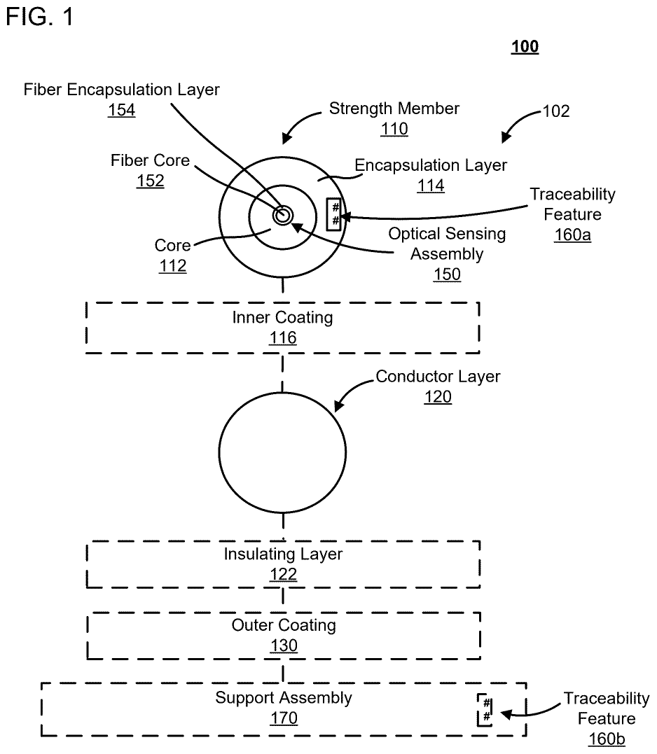

FIG. 1 is a schematic illustration of an assembly 100 including a conductor 102, according to an embodiment. The conductor 102 includes a strength member 110 and a conductor layer 120 disposed around the strength member 110. The strength member 110 includes a composite core 112 (also referred to herein as “core 112”) and an encapsulation layer 114 disposed around the core 112. In some embodiments, the conductor 102 can be coupled to a support assembly 170. A traceability feature 160a, 160b (collectively referred to as “traceability feature 160”) is incorporated in the strength member 110 and/or the support assembly 170. For example, in some embodiments, the traceability feature 160 may be incorporated in the core 112. In some embodiments, the traceability feature 160 may be incorporated in the encapsulation layer 114.

The core 112 may be formed from a composite material. In some embodiments, the composite material may include nonmetallic fiber reinforced metal matrix composite, carbon fiber reinforced composite of either thermoplastic or thermoset matrix, or composites reinforced with other types of fibers such as quartz, AR-Glass, E-Glass, S-Glass, H-Glass, silicon carbide, silicon nitride, alumina, basalt fibers, especially formulated silica fibers, any other suitable composite material, or any combination thereof. In some embodiments, the composite material includes a carbon fiber reinforced composite of a thermoplastic or thermoset resin. The reinforcement in the composite strength member(s) can be discontinuous, for example, include whiskers or chopped fibers, or continuous fibers in substantially aligned configurations (e.g., parallel to axial direction) or randomly dispersed (including helically wind or woven configurations). In some embodiments, the composite material may include a continuous or discontinuous polymeric matrix composite reinforced by carbon fibers, glass fibers, quartz, or other reinforcement materials, and may further include fillers or additives (e.g., nanoadditives). In some embodiments, the core 112 may include a carbon composite including a polymeric matrix of epoxy resin cured with anhydride hardeners.

The core 112 may have any suitable cross-sectional width (e.g., diameter). In some embodiments, the core 112 has a diameter in a range of about 3 mm to about 15 mm, inclusive of all values and ranges therebetween. For example, in some embodiments, the diameter of the core 112 may be about 3 mm, about 4 mm, about 5 mm, about 6 mm, about 7 mm, about 8 mm, about 9 mm, about 10 mm, about 11 mm, about 12 mm, about 13 mm, about 14 mm, or about 15 mm. In some embodiments, the diameter of the core 112 may be at least about 3 mm, at least about 4 mm, at least about 5 mm, at least about 6 mm, at least about 7 mm, at least about 8 mm, at least about 9 mm, at least about 10 mm, at least about 11 mm, at least about 12 mm, at least about 13 mm, or at least about 14 mm, inclusive of all values and ranges therebetween. In some embodiments, the diameter of the core 112 may be no more than about 15 mm, no more than about 14 mm, no more than about 13 mm, no more than about 12 mm, no more than about 11 mm, no more than about 10 mm, no more than about 9 mm, no more than about 8 mm, no more than about 7 mm, no more than about 6 mm, no more than about 5 mm, no more than about 4 mm, no more than about 3 mm, or no more than about 2 mm, inclusive of all values and ranges therebetween. Combinations of the above-referenced diameters of the core 112 are also possible (e.g., at least about 1 mm and no more than about 15 mm, or at least about 2 mm and no more than about 14 mm), inclusive of all values and ranges therebetween. In some embodiments, the core 112 may have a diameter in a range of about 5 mm to about 10 mm, inclusive. In some embodiments, the core 112 may have a diameter in a range of about 10 mm to about 15 mm, inclusive. In some embodiments, the core 112 may have a diameter in a range of about 7 mm to about 12 mm, inclusive. In some embodiments, the core 112 may have a diameter of about 9 mm.

The core 112 may have a first glass transition temperature (e.g., for thermoset composites), or melting temperature (e.g., for thermoplastic composites). In some embodiments, the first glass transition temperature or melting temperature may be in a range of about 100 degrees Celsius (° C.) to about 350 degrees Celsius, inclusive of all values and ranges therebetween. For example, in some embodiments, the first glass transition temperature may be about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., about 300° C., about 310° C., about 320° C., about 330° C., about 340° C., or about 350° C., inclusive of all values and ranges therebetween. In some embodiments, the first glass transition temperature may be at least about 70° C., at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 210° C., at least about 220° C., at least about 230° C., at least about 240° C., at least about 250° C., at least about 260° C., at least about 270° C., at least about 280° C., at least about 290° C., at least about 300° C., at least about 310° C., at least about 320° C., at least about 330° C., or at least about 340° C., inclusive of all values and ranges therebetween. In some embodiments, the first glass transition temperature may be no more than about 350° C., no more than about 340° C., no more than about 330° C., no more than about 320° C., no more than about 310° C., no more than about 300° C., no more than about 290° C., no more than about 280° C., no more than about 270° C., no more than about 260° C., no more than about 250° C., no more than about 240° C., no more than about 230° C., no more than about 220° C., no more than about 210° C., no more than about 200° C., no more than about 190° C., no more than about 180° C., no more than about 170° C., no more than about 160° C., no more than about 150° C., no more than about 140° C., no more than about 130° C., no more than about 120° C., no more than about 110° C., inclusive of all values and ranges therebetween. Combinations of the above-referenced first glass transition temperatures are also possible (e.g., at least about 70° C. and no more than about 350° C., or at least about 100° C. and no more than about 300° C.), inclusive of all values and ranges therebetween.

The glass transition temperature or melting temperature of the core 112 may correspond to a threshold operating temperature of the conductor 102, which may limit the ampacity of the conductor 102. In other words, a maximum amount of current that can be delivered through the conductor 102 is the current at which the operating temperature of the conductor 102, or at least the temperature of the core 112, is less than the glass transition temperature or melting temperature of the composite core 112.

In some embodiments, the core 112 defines a circular cross-section. In some embodiments, the core 112 may define an ovoid, elliptical, polygonal, or asymmetrical cross-section. In some embodiments, the strength member 110 may include a single core 112. In other embodiments, the strength member 110 may include multiple cores, for example, 2, 3, 4, or even more, with the encapsulation layer 114 being disposed around the multiple cores or around each individual core. In such embodiments, each of the multiple cores may be substantially similar to each other, or at least one of the multiple cores may be different from the other cores (e.g., have a different size, different shape, formed from a different material, have components such as the optical fiber assembly 150 embedded therein, etc.).

In some embodiments, an optical fiber assembly 150 (e.g., one or more optical fiber assemblies) may be disposed in the core 112. For example, the optical fiber assembly 150 may be embedded within the core 112 during the manufacturing of the core 112, or otherwise during manufacturing of the strength member 110. The optical fiber assembly 150 may be disposed axially along or otherwise parallel to a central axis of the core 112 and may extend along an entire length of the core 112, and thereby, the conductor 102. The optical fiber assembly 150 may include a fiber core 152 and a fiber encapsulation layer 154 disposed around the fiber core 152. The fiber core 152 may include an optical fiber (e.g., a single-mode optical fiber, a multi-mode optical fiber, a graded index fiber, a step index fiber, a glass optical fiber, a plastic optical fiber, any other suitable optical fiber or combination thereof) that is capable of transmitting optical energy or light having a wavelength in a range of about 100 nm to about 1 mm, inclusive of all values and ranges therebetween (e.g., from the ultraviolet to the infrared range).

In some embodiments, the fiber core 152 may also include a cladding (not shown) disposed around a central core (e.g., a glass cladding) and configured to inhibit transmission of optical energy therethrough to prevent transmission losses. Moreover, the fiber encapsulation layer 154 may include one or more layers, for example, a protective layer, a thermal resistant layer, an external jacket, and/or a moisture exclusion layer. Various examples of the optical fiber assembly 150 that may be disposed in the core 112 are described in PCT Publication No. WO2024/091951A1, filed Oct. 24, 2023, and entitled “Smart Composite Conductors and Methods of Making the Same,” the entire disclosure of which is incorporated herein by reference.

The encapsulation layer 114 is disposed around the core 112. For example, in some embodiments, the encapsulation layer 114 may be disposed circumferentially around the core 112. In some embodiments, the encapsulation layer 114 may be disposed on an outer surface of the core 112. In some embodiments, an inner insulation layer (not shown) may optionally be interposed between the core 112 and the encapsulation layer 114. The inner insulation layer may be formed from any suitable insulative material, for example, glass fibers (disposed either substantially parallel to axial direction or woven or braided glass), a resin layer, an insulative coating, any other suitable insulative material or a combination thereof. In some embodiments, the inner insulation layer may also be disposed on axial ends of the core 112, for example, to protect the axial ends of the core 112 from corrosive chemicals, environmental damage, etc.

The encapsulation layer 114 may be formed from any suitable electrically conductive or non-conductive material. In some embodiments, the encapsulation layer 114 may be formed from a conductive material including, but not limited to aluminum (e.g., 1350-H19), annealed aluminum (e.g., 1350-0), aluminum alloys (e.g., Al-Zr alloys, 6000 series Al alloys such 6201-TSI, -T82, -T83, 7000 series Al alloys, 8000 series Al alloys, etc.), copper, copper alloys (e.g., copper magnesium alloys, copper tin alloys, copper micro-alloys, etc.), any other suitable conductive material, or any combination thereof. In some embodiments, the encapsulation layer 114 is formed from Al and is pretensioned, i.e., is under tensile stress after being disposed on the core 112. In some embodiments, the encapsulation layer 114 may be formed from a non-conductive material, e.g., polymers, carbon fiber, glass fiber, ceramics, silicone, rubber, polyurethane, any other suitable non-conductive material, or a combination thereof.

The encapsulation layer 114 may be disposed on the core 112 using any suitable process. In some embodiments, the encapsulation process for disposing the encapsulation layer 114 around the core 112 may employ a conforming machine. For example, the encapsulation process may be performed with a similarly functional machine other than a conforming machine and be optionally further drawn to achieve target characteristics of the encapsulation layer 114 (e.g., a desired geometry or stress state). The conforming machines or the similar machines used for disposing the encapsulation layer 114 may allow quenching of the encapsulation layer 114. The conforming machine may be integrated with stranding machine, or with pultrusion machines used in making fiber reinforced composite strength members. While FIG. 1 shows a single encapsulation layer 114 disposed around the core 112, in some embodiments, multiple encapsulation layers 114 may be disposed around the core 112. In such embodiments, each of the multiple encapsulation layers 114 may be substantially similar to each other, or may be different from each other (e.g., formed from different materials, have different thicknesses, have different tensile strengths, etc.). In some embodiments, core 112 may include a carbon fiber reinforced composite, and the encapsulation layer 114 may include aluminum, for example, pretensioned or pre-compressed aluminum.

In some embodiments, an interface between the core 112 and the encapsulation layer 114 may include surface features, for example, grooves, slots, notches, indents, detents, etc. to enhance adhesion, bonding and/or interfacial locking between a radially outer surface of the core 112 and a radially inner surface of the encapsulation layer 114. Such surface features may facilitate retention and preservation of the stress from pre-tensioning in the encapsulation layer 114. In some embodiments, the composite core 112 may have a glass fiber tow disposed around its outer surface to create a screw shape or twisted surface. In some embodiments, a braided or woven fiber layer is applied in the outer layer of the core 112 to promote interlocking or bonding between the core 112 and the encapsulation layer 114.

In some embodiments, the encapsulation layer 114 may have a thickness in a range of about 0.3 mm to about 5 mm, inclusive of all values and ranges therebetween, or even higher. For example, in some embodiments, the encapsulation layer 114 may have a thickness of about 0.3 mm, about 0.5 mm, about 1.0 mm, about 1.5 mm, about 2.0 mm, about 2.5 mm, about 3.0 mm, about 3.5 mm, about 4.0 mm, about 4.5 mm, or about 5.0 mm, inclusive of all values and ranges therebetween, or even higher. In some embodiments, the thickness of the encapsulation layer 114 may be at least about 0.3 mm, at least about 0.5 mm, at least about 1.0 mm, at least about 1.5 mm, at least about 2.0 mm, at least about 2.5 mm, at least about 3.0 mm, at least about 3.5 mm, at least about 4.0 mm, or at least about 4.5 mm, inclusive of all values and ranges therebetween.

In some embodiments, the encapsulation layer 114 may have a minimum thickness to inhibit exposure of the core 112 to the external environment or environmental conditions (e.g., moisture, harsh temperatures, etc.). For example, in some embodiments in which the traceability feature 160 is incorporated in the encapsulation layer 114, the encapsulation layer 114 may have the minimum thickness to prevent damage to the encapsulation layer 114, the core 112, or a combination thereof. In some embodiments, the minimum thickness of the encapsulation layer 114 may be in a range of about 0.3 mm to about 5.0 mm, inclusive of all values and ranges therebetween. In some embodiments, the encapsulation layer 114 may have a minimum thickness of at least about 0.3 mm, at least about 0.5 mm, at least about 1.0 mm, at least about 1.5 mm, at least about 2.0 mm, at least about 2.5 mm, at least about 3.0 mm, at least about 3.5 mm, at least about 4.0 mm, at least about 4.5 mm, or at least about 5.0 mm, inclusive. In some embodiments, the thickness of the encapsulation layer 114 may be no more than about 5.0 mm, no more than about 4.5 mm, no more than about 4.0 mm, no more than about 3.5 mm, no more than about 3.0 mm, no more than about 2.5 mm, no more than about 2.0 mm, no more than about 1.5 mm, no more than about 1.0 mm, or no more than about 0.5 mm, inclusive of all values and ranges therebetween. Combinations of the above-referenced thicknesses of the encapsulation layer 114 are also possible (e.g., at least about 0.3 mm and no more than about 5.0 mm, or at least about 0.5 mm and no more than about 4.5 mm), inclusive of all values and ranges therebetween.

In some embodiments, a ratio of an outer diameter of the encapsulation layer 114 to an outer diameter of the core 112 is in range of about 1.2:1 to about 5:1, inclusive of all values and ranges therebetween. For example, in some embodiments, the ratio of the outer diameter of the encapsulation layer 114 to the outer diameter of the core 112 is about 1.2:1, about 1.5:1, about 2:1, about 2.5:1, about 3:1, about 3.5:1, about 4:1, about 4.5:1, or about 5:1, inclusive of all ratios therebetween. In some embodiments, the ratio of the outer diameter of the encapsulation layer 114 to the outer diameter of the core 112 is at least about 1.2:1, at least about 1.5:1, at least about 2:1, at least about 2.5:1, at least about 3:1, at least about 3.5:1, at least about 4:1, or at least about 4.5:1, inclusive of all values and ranges therebetween. In some embodiments, the ratio of the outer diameter of the encapsulation layer 114 to the outer diameter of the core 112 is no more than about 5:1, no more than about 4.5:1, no more than about 4.0:1, no more than about 3.5:1, no more than about 3.0:1, no more than about 2.5:1, no more than about 2.0:1, or no more than about 1.5:1, inclusive of all values and ranges therebetween. Combinations of the above-referenced ratio of the outer diameter of the encapsulation layer 114 to the outer diameter of the core 112 are also possible (e.g., at least about 1.2:1 and no more than about 5:1, or at least about 1.5:1 and no more than about 4.5:1), inclusive of all values and ranges therebetween. In some embodiments, the encapsulation layer 114 may be excluded.

In some embodiments, the strength member 110 may have a minimum level of tensile strength, for example, at least 600 MPa (e.g., at least 600, at least 700, at least 800, at least 1,000, at least 1,200, at least 1,400, at least 1,600, at least 1,800, or at least 2,000 MPa). In some embodiments, the elongation during pretension of the strength member 110 may include elongation by at least 0.01% strain (e.g., at least 0.01%, at least 0.05%, at least 0.1%, at least 0.15%, at least 0.2%, at least 0.25%, at least 0.3%, at least 0.35%, at least 0.4%, at least 0.45%, or at least 0.5% strain, inclusive) depending on the type of strength members and the degree of knee point reduction, and the strength member 110 may be pre-tensioned before or after entering the conforming machine. Moreover, the strength member 110 may be configured to endure radial compression from crimping of conventional fittings as well as radial pressure during conforming of drawing down process or folding and molding of at least 3 kN (e.g., at least 3, at least 4, at least 5, at least 10, at least 15, at least 20, or at least 25 KN, inclusive), for example for composite cores 112 with little to substantially no plastic deformation.

In some embodiments, the encapsulation layer 114 may have an outer surface that is configured to be smooth and shiny (e.g., surface treated) so as to reduce absorptivity (i.e., enhance solar reflectivity) so as to reduce an operating temperature of the core 112 and to prevent the temperature of the core 112 from exceeding its glass transition temperature or melting temperature. As described in further detail herein, the outer coating 130 may be formulated to have high radiative emissivity in the 2.5 microns to 15 microns wavelength, inclusive of the solar radiation. While this may cause cooling of the conductor layer 120, the radiated heat will also travel towards the strength member 110 and cause heating of the core 112, for example, cause the core 112 to be at a higher operating temperature than the conductor layer 120, which is undesirable. To reduce absorption of this emitted radiation, the outer surface of the encapsulation layer 114 may be sufficiently reflective so as to have solar absorptivity of less than 0.6 (e.g., less than 0.55, less than 0.5, less than 0.45, less than 0.4, less than 0.35, less than 0.3, less than 0.25, less than 0.2, less than 0.15, or less than 0.1, inclusive) at a wavelength in a range of 2.5 microns to 15 microns, inclusive (e.g., 2.5, 3.0, 3.5, 4.0, 4.5, 5.0, 5.5, 6.0, 6.5, 7.0, 7.5, 8.0, 8.5, 9.0, 9.5, 10.0, 11, 12, 13, 14, or 15 microns, inclusive), at an operating temperature of the conductor 102 in a range of 90 degrees Celsius to 250 degrees Celsius, inclusive (e.g., 90, 100, 120, 140, 160, 180, 200, 220, 240, or 250 degrees Celsius, inclusive).

In some embodiments, the strength member 110 may be optionally coated with an inner coating 116 to reduce solar absorptivity. For example, in some embodiments, the outer surface of the core 112 may be coated with the inner coating 116. In some embodiments, the outer surface of the encapsulation layer 114 may be coated with the inner coating 116. For example, the inner coating 116 may be disposed between the encapsulation layer 114 and the conductor layer 120. In some embodiments, the inner coating 116 may be formulated to have an absorptivity of less than 0.6 (e.g., less than 0.6, less than 0.55, less than 0.5, less than 0.45, less than 0.4, less than 0.35, less than 0.3, less than 0.25, less than 0.2, less than 015, or less than 0.1, inclusive) at a wavelength in a range of 2.5 microns to 15 microns, inclusive (e.g., 2.5, 3.0, 3.5, 4.0, 4.5, 5.0, 5.5, 6.0, 6.5, 7.0, 7.5, 8.0, 8.5, 9.0, 9.5, 10.0, 11.0, 12.0, 13.0, 14.0, or 15.0 microns, inclusive), at an operating temperature of the conductor 102 in a range of 90 degrees Celsius to 250 degrees Celsius, inclusive (e.g., 90, 100, 120, 140, 160, 180, 200, 220, 240, or 250 degrees Celsius, inclusive). The inner coating 116 may be configured to reflect a substantial amount of solar radiation in the wavelength of equal to or less than 2.5 microns (e.g., at least 50% of solar radiation in a wavelength of equal to or less than 2.5 microns that is incident on the encapsulation layer 114). In some embodiments, a thickness of the inner coating 116 may be in a range of about 1 micron to about 500 microns, inclusive (e.g., 1, 5, 10, 20, 30, 40, 50, 60, 70, 80, 90, 100, 150, 200, 250, 300, 350, 400, 450, or 500 microns, inclusive).

In some embodiments, the inner coating 116 may have a reflectivity of greater than about 50% (e.g., greater than 50%, greater than 60%, greater than 65%, greater than 70%, greater than 75%, greater than 80%, greater than 85%, greater than 90%, or greater than 95%, inclusive) at thermal radiative wavelengths corresponding to an operating temperature of greater than about 90 degrees Celsius. As previously described, the strength member 110 may include a composite core 112 that may be black in color (e.g., includes a carbon composite). The core 112 may therefore, act as a black body absorbing radiation causing the core 112 to have a higher temperature relative to the conductor layer 120 or otherwise, the encapsulation layer 114. This may further reduce an upper limit of the operating temperature of the conductor 102 by up to 10 degrees Celsius, thus constraining the ampacity of the conductor 102. In contrast, the encapsulation layer 114 having the highly reflective outer surface, and/or the inner coating 116 having low solar absorptivity reflect a substantial portion of the heat emitted by the conductor layer 120 back into the environment. This may facilitate lowering an operating temperature of core 112, therefore protecting the core 112 and allowing the conductor 102 to operate at a higher temperature relative to the core 112 so as to inhibit the temperature of the core 112 from exceeding a threshold temperature (e.g., its glass transition temperature or melting point). In some embodiments, the inner coating 116 may include any inner coating having any suitable structure and function as described in detail in U.S. Pat. No. 11,854,721, filed Mar. 24, 2023, and entitled “Composite Conductors Including Radiative and/or Hard Coatings and Methods of Manufacture Thereof,” (hereinafter referred to as the “'721 patent”) the entire disclosure of which is incorporated herein by reference.

The traceability feature 160 may be incorporated in the strength member 110. For example, in some embodiments, the traceability feature 160 may be incorporated (e.g., disposed, etched, embedded, implanted, engraved, stamped, casted, formed, included, etc.) in or on at least one of the core 112 or the encapsulation layer 114. In some embodiments, the traceability feature 160 is incorporated in the encapsulation layer 114. For example, the traceability feature 160 may be disposed (e.g., etched, engraved, stamped, casted, formed, etc.) on the encapsulation layer 114, the traceability feature 160 may be embedded in the encapsulation layer 114, the traceability feature 160 may be implanted in the encapsulation layer 114, or any suitable combination thereof. In some embodiments, the traceability feature 160 may be disposed on an outer surface of the encapsulation layer 114. In some embodiments, the traceability feature 160 may be disposed on an inner surface of the encapsulation layer 114. For example, the traceability feature 160 may be disposed at an interface of the core 112 and the encapsulation layer 114, or formed on an inner surface of the encapsulation layer 114 that faces the core 112. In some embodiments, the traceability feature 160 is incorporated in the core 112. For example, the traceability feature 160 may be disposed on the core 112 (e.g., etched, engraved, stamped, casted, formed, etc., on an outer surface of the core 112), formed in the core 112, embedded in the core 112, implanted in the core 112, or any suitable combination thereof such that the traceability feature 160 is disposed beneath the encapsulation layer 114.

As described in further detail herein, the conductor layer 120 is disposed on the strength member 110, for example, wrapped around the strength member 110. Because the traceability feature 160 is incorporated in strength member 110 (e.g., incorporated in the core 112 or the encapsulation layer 114) and the conductor layer 120 disposed around the strength member 110 the traceability feature 160 is disposed beneath the conductor layer 120. Thus, the conductor layer 120 serves to shield the traceability feature 160 from environmental elements, for example, by inhibiting ingress of moisture, abrasive particulate matter, solar radiation, rain, ice, and other environmental elements to the strength member 110, and, thereby, the traceability feature 160. Thus, the traceability feature 160 may have a much longer life relative to traceability features included in conventional conductors that are formed on outer surfaces of such conventional conductors and may last the serviceable lifetime of the conductor 102. In some embodiments, small quantities of moisture elements may ingress through the conductor layer 120 onto the traceability feature 160 but may be sufficiently small as not to substantially degrade the traceability feature 160 over the serviceable lifetime of the conductor 102. In such implementations, the traceability feature 160 may also be used as a sensor to determine an amount of exposure of the conductor 102 to moisture, heat, solar radiation, etc., a location of the conductor 102, and/or temperature variations experienced by the conductor 102.

In some embodiments, the traceability feature 160 is disposed proximal to an axial end of the strength member 110. For example, the traceability feature 160 may be disposed in a range of about 1 mm to about 1 m, inclusive of all values and ranges therebetween (e.g., about 1 mm, 5 mm, 1 cm, 10 cm, 50 cm, 75 cm, 90 cm, or 1 m, inclusive) from an axial end of the strength member 110. This may, for example, allow for easy detection of the traceability feature 160 in the field because an axial end point may be used as a point of reference. In some embodiments, the traceability feature 160 may be disposed proximate an axial center point of the strength member 110, for example, at the axial center point. In some embodiments, the traceability feature 160 may be located at a distance in a range of about 1 mm to about 1 m, inclusive, on either side of the axial center point of the strength member 110. In some embodiments, a plurality of traceability features may be incorporated in the strength member 110 at any suitable locations of the strength member 110 (e.g., proximate to each axial end of the strength member 110, at or proximate to the axial center point of the strength member, and/or incorporated at various locations along the length of the strength member 110 and spaced apart by a predetermined distance from each other).

In some embodiments, the traceability feature 160 includes a marking, an etching, an engraving, a stamp, a print, an imprint, a scrape, a burn, or a combination thereof. For example, the traceability feature 160 may include a laser marking, a chemical etching, a printed mark, a stamp mark, and/or a burn mark. Such markings may be disposed on any surface of the strength member 110, for example, disposed on the outer surface of the encapsulation layer 114 at any suitable location.

In some embodiments, the traceability feature 160 may include a groove, for example, one or more grooves formed or etched on an outer surface of the encapsulation layer 114 in the shape of a pattern (e.g., an alphanumeric pattern, a symbol, a bar code, a graphic pattern, etc.). In some embodiments, the groove may include a groove depth in a range of about 0.1 microns (i.e., μm) to about 500 microns, inclusive of all values and ranges therebetween. For example, in some embodiments, the groove depth of the traceability feature 160 may be about 0.1 μm, about 0.5 μm, about 1 μm, about 5 μm, about 10 μm, about 20 μm, about 30 μm, about 40 μm, about 50 μm, about 60 μm, about 70 μm, about 80 μm, about 90 μm, about 100 μm, about 150 μm, about 200 μm, about 250 μm, about 300 μm, about 350 μm, about 400 μm, about 450 μm, or about 500 μm, inclusive of all values and ranges therebetween. In some embodiments, the groove depth for the traceability feature 160 may be at least about 0.1 μm, at least about 0.5 μm, at least about 1 μm, at least about 5 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 150 μm, at least about 200 μm, at least about 250 μm, at least about 300 μm, at least about 350 μm, at least about 400 μm, or at least about 450 μm, inclusive of all values and ranges therebetween. In some embodiments, the groove depth for the traceability feature 160 may be no more than about 500 μm, no more than about 450 μm, no more than about 400 μm, no more than about 350 μm, no more than about 300 μm, no more than about 250 μm, no more than about 200 μm, no more than about 150 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 5 μm, no more than about 1 μm, or no more than about 0.5 μm, inclusive of all values and ranges therebetween. Combinations of the above-referenced groove depths for the traceability feature 160 are also possible (e.g., at least about 0.1 μm and no more than about 500 μm, or at least about 0.5 μm and no more than about 450 μm), inclusive of all values and ranges therebetween. In some embodiments, the groove may include a combination of various groove depths. The groove may, for example, be incorporated in, or disposed on, the outer surface of the encapsulation layer 114. In some embodiments, the traceability feature 160 may include one or more grooves, for example, the traceability feature 160 may include a plurality of grooves.

In some embodiments, the traceability feature 160 is formed via laser marking, laser etching, laser engraving, mechanical engraving, intaglio printing, stamping, or a combination thereof. For example, the traceability feature 160 may be a laser mark formed via laser marking.

In some embodiments, the traceability feature 160 may define a shape or include a boundary defining a shape. For example, the shape may be a rectangle, a square, a triangle, a circle, an oval, an ellipse, a polygon, any other suitable shape, or a combination thereof. In some embodiments, the traceability feature 160 does not define a shape or does not include a boundary defining a shape.

In some embodiments, the traceability feature 160 may include a barcode, a quick-response (QR) code, an alphanumeric character, a symbol, an image, any other information-carrying mark or feature, or a combination thereof. For example, the traceability feature 160 may include a plurality of alphanumeric characters, symbols, or images independent of, or in combination with, a barcode, a quick-response (QR) code, or a combination thereof. In some embodiments, the traceability feature 160 may include a serial number, a product number, a purchase order number, a work order number, a date of installation, any other information important for tracking the conductor, or a combination thereof. In some embodiments, the traceability feature 160 can include manufacturing data, installation parameters, conductor rating, usage history, and/or authentication credentials.

In some embodiments, the traceability feature 160 may include a communication device (not shown). In some embodiments, the communication device is a wireless communication device. For example, the traceability feature 160 may include a communication device including a radio-frequency identification (RFID) tag, a Near Field Communication (NFC) chip, a Bluetooth transmitter, a microcontroller, a microcomputer, a microprocessor, a device configured to transmit information to an authorized user, or a combination thereof. In some embodiments, the RFID tag can enable identification, authentication, lifecycle tracking, installation verification, and/or remote monitoring of conductors and splicing points (e.g., joints). The communication device may include a processor (e.g., a microchip or microprocessor) for storing or processing information, a receiver, a transmitter, a substrate, an enclosure (e.g., a casing), or a combination thereof. In some embodiments, the communication device may include an antenna which acts as a receiver, a transmitter, or a combination thereof.

In some embodiments, the microchip and the antenna can form a transponder which can represent a data-carrying device for the traceability feature 160 including the RFID tag. In some embodiments, the antenna can transmit the data to a reader, regardless of whether the reader can only read data or the reader is also capable of writing (e.g., communicating information to the traceability feature 160). In some embodiments, the transponder can be passive when it is not within an interrogation zone of a reader. In some embodiments, the transponder can be activated when it is within the interrogation zone of the reader. The power required to activate the transponder can be supplied to the transponder through a coupling element (e.g., antenna). The antenna can be optimized based on the mechanical constraints and/or the electromagnetic limitations in order to provide an adequate read range. In some embodiments, the RFID tag can include significant benefits including greater flexibility in read range and larger data storage capabilities compared to other communication devices. Another benefit of RFID tag is that it can identify the conductor 102 and/or track its current state, its past state, and/or its future state.

In some embodiments, the communication device may be incorporated in the strength member 110, for example, incorporated in the core 112 or incorporated in the encapsulation layer 114. In some embodiments, the communication device may be incorporated in the conductor layer 120. In some embodiments, the communication device (e.g., the RFID tag) can be positioned in a depth corresponding to about 10% to about 50% of the total thickness of the encapsulation layer 114, inclusive of all ranges and values in between. In some embodiments, the communication device (e.g., the RFID tag) can be positioned in a depth corresponding to at least about 10%, at least about 15%, at least about 20%, at least about 25%, at least about 30%, at least about 35%, at least about 40%, at least about 45%, or at least about 50% of the total thickness of the encapsulation layer 114. In some embodiments, the communication device (e.g., the RFID tag) can be positioned in a depth corresponding to no more than about 50%, no more than about 45%, no more than about 40%, no more than about 35%, no more than about 30%, no more than about 25%, no more than about 20%, no more than about 15%, or no more than about 10% of the total thickness of the encapsulation layer 114. In some embodiments, the communication device (e.g., the RFID tag) can be positioned in a depth corresponding to about 50%, about 45%, about 40%, about 35%, about 30%, about 25%, about 20%, about 15%, or about 10% of the total thickness of the encapsulation layer 114. Such placement can provide sufficient dielectric spacing from the core 112 to minimize electromagnetic interference while allowing external interrogation of the RFID tag. Such placement can also protect the RFID tag from mechanical damage, and/or environmental exposure.

In some embodiments, the traceability feature 160 may be incorporated into a support assembly 170. In some embodiments, the support assembly 170 can include a coupler or a suspension clamp, coupled to the conductor 102. In some embodiments, the support assembly 170 can be a dead-end coupler or a splice coupler. A dead-end coupler can connect an end portion of the conductor 102 to a structure. For example, the dead-end coupler can couple the conductor 102 to a pole, or tower, or any other suitable structure. The dead-end coupler can transfer mechanical load to the pole, the tower, or the structure. The dead-end coupler can include sleeves, connection portion, a plurality of grooves incorporated in the sleeve, and a body.

In some embodiments, the support assembly 170 can be a splice coupler that connects two conductors 102 to each other, for example, maintain continuity and mechanical strength. The splice coupler can extend the transmission lines (e.g., allow longer conductors to be made from shorter spans) or can be used for repairing broken sections of conductors 102.

In some embodiments, the support assembly 170 can be a suspension clamp that can support the conductor 102 by holding the conductor 102 in place at the tower or the pole, for example, allowing it to hang freely and maintain proper tension. The suspension clamp can permit slight movement of the conductor 102 due to wind, thermal expansion, or mechanical vibration, thereby reducing mechanical fatigue. In some embodiments, the suspension clamp can include padding or inserts to prevent abrasion or crushing of the conductor 102. The suspension clamp can further provide electrical insulation between the conductor 102 and the supporting structure. Suspension clamp can be one of a standard suspension clamp for straight-line spans, a trunnion type for allowing rotation and flexibility, an armor grip suspension for protecting the conductor from bending stress via including preformed rods, or a vibration dampening clamp for reducing vibration.

In some embodiments, the traceability feature 160 (e.g., RFID tag) can be disposed on a housing of the support assembly 170. In some embodiments, the traceability feature 160 can be coupled to the sleeves of the coupler. For example, because metal can affect the RFID tag performance (e.g., by interfering with electromagnetic energy transfer), the traceability feature 160—may be disposed proximate to a dielectric exterior. In some embodiments, the RFID tag can be embedded within a dielectric insert or pocket in the sleeve of the coupler such that the RFID tag lies at a distance of about 0.5 mm to about 3 mm from the inner face of the pocket, inclusive of all ranges and values in between, to be sufficiently distant from metal.

In some embodiments, the RFID tag can be embedded within a dielectric insert or pocket in the sleeve of the coupler such that the RFID tag lies at a distance of at least about 0.5 mm, at least about 1 mm, at least about 1.25 mm, at least about 1.5 mm, at least about 1.75 mm, at least about 2 mm, at least about 2.25 mm at least about 2.5, at least about 2.75 mm, or at least about 3 mm from the inner face of the pocket. In some embodiments, the RFID tag can be embedded within a dielectric insert or pocket in the sleeve of the coupler such that the RFID tag lies at a distance of no more than about 3 mm, no more than about 2.75 mm, no more than about 2.5 mm, no more than about 2.25 mm, no more than about 2 mm, no more than about 1.75 mm, no more than about 1.5 mm no more than about 1.25, no more than about 1 mm, or no more than about 0.5 mm from the inner face of the pocket. Combinations of the above-referenced distances are also possible (e.g., at least about 0.5 mm and no more than about 3 mm or at least about 1 mm and no more than about 2 mm). In some embodiments, the RFID tag can be embedded within a dielectric insert or pocket in the sleeve of the coupler such that the RFID tag lies at a distance of about 0.5 mm, about 1 mm, about 1.25 mm, about 1.5 mm, about 1.75 mm, about 2 mm, about 2.25 mm, about 2.5, about 2.75 mm, or about 3 mm from the inner face of the pocket.

In some embodiments, the RFID tag can be embedded within a dielectric insert or pocket in the sleeve of the coupler such that the RFID tag lies at a distance of about 0.5 mm to 5 mm from the sleeve's outer surface for readability, inclusive of all values and ranges in between. In some embodiments, the RFID tag can be embedded within a dielectric insert or pocket in the sleeve of the coupler such that the RFID tag lies at a distance of at least about 0.5 mm, at least about 1 mm, at least about 1.25 mm, at least about 1.5 mm, at least about 1.75 mm, at least about 2 mm, at least about 2.25 mm at least about 2.5, at least about 2.75 mm, or at least about 3 mm, at least about 3.25 mm, at least about 3.5 mm, at least about 3.75 mm, at least about 4 mm, at least about 4.25 mm, at least about 4.5 mm, at least about 4.75 mm, or at least about 5 mm, inclusive from the sleeve's outer surface. In some embodiments, the RFID tag can be embedded within a dielectric insert or pocket in the sleeve of the coupler such that the RFID tag lies at a distance of no more than about 5 mm, no more than about 4.75 mm, no more than about 4.5 mm, no more than about 4.25 mm, no more than about 4 mm, no more than about 3.75 mm, no more than about 3.5 mm no more than about 3.25, no more than about 3 mm, no more than about 2.75 mm, no more than about 2.5 mm, no more than about 2.25 mm, no more than about 2 mm, no more than about 1.75 mm, no more than about 1.5 mm no more than about 1.25, no more than about 1 mm, or no more than about 0.5 mm, inclusive from the sleeve's outer surface. Combinations of the above-referenced distances are also possible (e.g., at least about 0.5 mm and no more than about 5 mm or at least about 1 mm and no more than about 2 mm). In some embodiments, the RFID tag can be embedded within a dielectric insert or pocket in the sleeve of the coupler such that the RFID tag lies at a distance of about 0.5 mm, about 1 mm, about 1.25 mm, about 1.5 mm, about 1.75 mm, about 2 mm, about 2.25 mm, about 2.5, about 2.75 mm, about 3 mm, about 3.25 mm, about 3.5 mm, about 3.75 mm, about 4 mm, about 4.25 mm, about 4.5, about 4.75 mm, or about 5 mm, inclusive from the sleeve's outer surface for readability.

In some embodiments, the traceability feature 160 can be activated when the conductor 102 is coupled to the support assembly 170. In some embodiments, the traceability feature 160 can be configured to generate a signal when the conductor 102 is coupled to the support assembly 170. In some embodiments, the traceability feature 160 can be incorporated in both the conductor 102 and the support assembly 170. In some embodiments, the traceability feature 160 can enable automatic confirmation of correct connection between the conductor 102 and the support assembly 170. In some embodiments, the traceability feature 160 can change or disable upon decoupling of the conductor 102 and the support assembly 170. For example, an electrical fuse can be incorporated into the traceability feature 160 that can break upon decoupling of the conductor 102 and the support assembly 170.

In some embodiments, the traceability feature 160 may be activated via electrical energy transmitting through the conductor 102. For example, the traceability feature 160 may be integrated into a circuit with the conductor 102 thereby receiving electrical power directly via the conductor. In some embodiments, the traceability feature 160 may be activated remotely to transmit information to a cellphone or computer device.

In some embodiments, the traceability feature 160 can include the RFID tag [e.g., an ultrahigh frequency (UHF) or surface acoustic wave (SAW) type RFID tag]. The RFID tag can enable wireless interrogation while minimizing interference from surrounding conductive materials. In some embodiments, the RFID tag can be resistant to chemicals, moisture, and/or mechanical stress. In some embodiments, the RFID tag can include a housing which can protect the RFID tag from temperature extremes, moisture, humidity, and chemical exposure. The housing can also shield the processor (e.g., chip) and antenna from physical damage due to vibration, impact, and/or abrasion. In some embodiments, the housing of the RFID tag can prevent interference from the conductor's electromagnetic fields and/or electrical currents.

In some embodiments, a processor can be electrically coupled to the antenna. In some embodiments, the impedance matching between the processor and the antenna can be critical to maximize power transfer and signal efficiency. In some embodiments, the bonding between the processor and the antenna can be via wire bonding via gold or aluminum or conductive adhesives such as conductive epoxies.

In some embodiments, the RFID tag can include at least one of ceramics, high temperature polymers such as PEEK or PTFE, or metals, and can include RF transport windows or slots. In some embodiments, the antenna of the RFID tag can include copper, aluminum, silver ink, and/or high-temperature alloys. In some embodiments, the substrate of the antenna can include polyimide (e.g., KAPTON®). In some embodiments, a base layer of the RFID tag can support the transponder and the antenna. In some embodiments, the base layer of the RFID tag can include a flexible and heat-resistant polymer such as polyimide. In some embodiments, the base layer can include fiberglass epoxy. In some embodiments, the base layer can include ceramic.

In some embodiments, the coupling the RFID tag to the support assembly 170 can enable the RFID tag to withstand thermal expansion and/or contraction. In some embodiments, the coupling the RFID tag to the support assembly 170 may not interfere with conductor 102 performance. In some embodiments, coupling the RFID tag to the support assembly 170 can maintain the integrity of the RFID tag under vibration and/or mechanical stress. The manner in which the RFID tag is coupled or integrated into the conductor 102 can be chosen based on the location of the coupling. For example, the coupling mechanism can vary depending on whether the RFID tag is coupled to the conductor layer 120, the encapsulation layer 114, or the support assembly 170. In some embodiments, the RFID tag coupling may be achieved using adhesives, mechanical fasteners e.g., clamps, brackets, or integrated housings), overmolding, or other suitable attachment techniques. In some embodiments, the adhesive can be a high temperature resistant adhesive.

In some embodiments, the coupling between the RFID and the strength member 110 or support assembly 170 can be permanent or removable. In some embodiments, the coupling between the RFID and the strength member 110 or support assembly 170 can be configured to withstand environmental stressors such as high temperatures, UV exposure, moisture, and mechanical vibration. In some embodiments, the RFID tag can use the metal content of the conductor 102 as an antenna (i.e., use the conductor 102 itself as a transmission antenna), thereby eliminating the space required for an internal antenna or communication interface. In some embodiments, the RFID tag can withstand repeated exposure to harsh environments.

In some embodiments, the RFID tag can be configured to be traced from (i.e., can be communicated with) a distance of about 10 m, about 15 m, about 20 m, about 25 m, about 30 m, about 35 m, about 40 m, about 45 m, or about 50 m, inclusive of all values and ranges therebetween. In some embodiments, the RFID tag can be traced from a distance of at least about 10 m, at least about 15 m, at least about 20 m, at least about 25 m, at least about 30 m, at least about 35 m, at least about 40 m, at least about 45 m or at least about 50 m. In some embodiments, the RFID tag can be traced from a distance of no more than about 50 m, no more than about 45 m, no more than about 40 m, no more than about 35 m, no more than about 30 m, no more than about 25 m, no more than about 20 m, no more than about 15 m, or no more than about 10 m.

Combinations of the above-referenced proximities are also possible (e.g., at least about 10 m and no more than about 50 m or at least about 30 m and no more than about 40 m), inclusive of all values and ranges therebetween.

In some embodiments, the RFID tag can include a high temperature rated RFID tag. In some embodiments, the high temperature rated RFID tag is capable of operating under continuous, intermittent, or periodic exposure to temperatures in a range of about 150° C. to about 300° C., inclusive. For example, in some embodiments, the high temperature rated RFID tag can be configured to operate at a temperature of about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., or about 300° C., inclusive. In some embodiments, the high temperature rated RFID tag can be can be configured to operate at a temperature of at least about 150° C., at least about 160° C., at least about 170° C., at least about 180° C., at least about 190° C., at least about 200° C., at least about 210° C., at least about 220° C., at least about 230° C., at least about 240° C., at least about 250° C., at least about 260° C., at least about 270° C., at least about 280° C., at least about 290° C., or at least about 300° C., inclusive. In some embodiments, the high temperature rated RFID tag can be can be configured to operate at a temperature of no more than about 300° C., no more than about 290° C., no more than about 280° C., no more than about 270° C., no more than about 260° C., no more than about 250° C., no more than about 240° C., no more than about 230° C., no more than about 220° C. μm, no more than about 210° C., no more than about 200° C., no more than about 190° C., no more than about 180° C., no more than about 170° C., no more than about 160° C., or no more than about 150° C., inclusive. Combinations of the above-referenced temperatures are also possible (e.g., at least about 150° C. and no more than about 300° C., or at least about 200° C. and no more than about 250° C.).

In some embodiments, the high temperature RFID tag can include at least one of a ceramic or a high temperature resistant polymer or a metal housing to protect the processor and the antenna. In some embodiments, the high temperature RFID tag may be incorporated in the strength member 110, for example, incorporated in the core 112 or incorporated in the encapsulation layer 114. In some embodiments, the high temperature RFID tag may be incorporated in the conductor layer 120. In some embodiments, the traceability feature 160 can include an ultra-high frequency (UHF) identifier, for example, a UHF RFID tag. In some embodiments, the UHF RFID tag can enable long-range wireless communication, for example, operating within a frequency range of about 860 MHz to 960 MHz, inclusive of all ranges and values in between. In some embodiments, the UHF RFID tag can operate at a frequency of at least about 860 MHz, at least about 870 MHz, at least about 880 MHz, at least about 890 MHz, at least about 900 MHz, at least about 910 MHz, at least about 920 MHz, at least about 930 MHz, at least about 940 MHz, at least about 950 MHz, or at least about 960 MHz, inclusive. In some embodiments, the UHF RFID tag can operate at a frequency of no more than about 960 MHz, no more than about 950 MHz, no more than about 940 MHz, no more than about 930 MHz, no more than about 920 MHz, no more than about 910 MHz, no more than about 900 MHz, no more than about 890 MHz, no more than about 880 MHz, no more than about 870 MHz, or no more than about 860 MHz, inclusive. Combinations of the above-referenced frequencies are also possible (e.g. at least about 860 MHz, and no more than about 960 MHz, or at least about 900 MHz and no more than about 920 MHz), inclusive of all values and ranges therebetween. In some embodiments, the frequency of the UHF RFID tag can be about 860 MHz, about 870 MHz, about 880 MHz, about 890 MHz, about 900 MHz, about 910 MHz, about 920 MHz, about 930 MHz, about 940 MHz, about 950 MHz, or about 960 MHz, inclusive. In some embodiments, the UHF RFID tag can be passive, drawing power from the reader's signal. In some embodiments, the UHF RFID tag can be active incorporating an internal power source to enable extended read ranges and data storage capabilities. The UHF RFID tag may be configured to store identification data, operational parameters, or maintenance history associated with the conductor 102 or associated hardware. The UHF RFID tag may be affixed to or embedded within various components of the system, including the strength member 110, the encapsulation layer 114, or the support assembly 170 such as a coupler, splice, or suspension clamp.

The attachment may be achieved using adhesives, mechanical fasteners, or overmolding techniques, and the tag may be encapsulated in a high-temperature-resistant housing to ensure durability in harsh environmental conditions. In some embodiments, the traceability feature 160 can include a surface acoustic wave (SAW) RFID tag. In some embodiments, SAW RFID tags use piezoelectric materials (e.g., quartz or lithium niobate) that convert electrical signals to mechanical (acoustic) waves and vice versa. In some embodiments, the SAW RFID tag can send a radio signal, and the tag's antenna can receive and convert the radio signal into an acoustic wave that travels across the surface of the piezoelectric substrate. The acoustic wave can interact with reflectors on the tag, which encode information based on their spacing and pattern. The reflected wave can then be converted back into an RF signal and be transmitted back to the reader. In some embodiments, the SAW RFID tags can operate at high temperatures (e.g., temperatures up to about 400° C.). In some embodiments, the SAW RFID can be passive (e.g., with no internal power source). In some embodiments, the SAW RFID tag can operate without power supply and/or complex electronics. In some embodiments, the SAW RFID tag can be resistant to radiation and electromagnetic interference. In some embodiments, the SAW RFID tags can endure harsh environmental conditions. The SAW RFID tags can provide various benefits including, for example, high temperature tolerance, being passive, and/or less sensitivity to electromagnetic interference from the conductor 102.

In some embodiments, the traceability feature 160 may include a temperature indicator configured to indicate an operating temperature of the strength member 110. For example, the temperature indicator may be configured to visually indicate maximum thermal exposure of the conductor 102 (e.g., experience a change in color based on operating temperature of the conductor 102). Examples of visual thermal indicators include, but are not limited to thermochromic paints, temperature indicating stickers (e.g., SPOTSEE THERMAX® labels), any other suitable thermal indicators or combination thereof.

In some embodiments, the temperature indicator can be coupled to a communication device. For example, the temperature indicator can include a local temperature sensor communicably coupled with the communication device to transmit at least local temperature data. In some embodiments, the communication device can include an antenna. In some embodiments, the antenna can transmit the data to a reader. In some embodiments, the temperature indicator can be resistant to harsh environment. In some embodiments, the temperature indicator can be resistant to oil, water, and/or steam. In some embodiments, the temperature indicator can be a temperature-sensitive label coupled to the strength member 110 to permanently record the highest temperature reached by the strength member 110. In some embodiments, the temperature-sensitive label can change color, irreversibly.

In some embodiments, the temperature sensitive label can record a temperature range of about 30° C. to about 350° C., inclusive of all values and ranges therebetween. For example, in some embodiments, the temperature sensitive label can record the temperature of at least about 30° C., at least about 40° C., at least about 50° C., at least about 60° C., at least about 70° C., at least about 80° C., at least about 90° C., at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 210° C., at least about 220° C., at least about 230° C., at least about 240° C., at least about 250° C., at least about 260° C., at least about 270° C., at least about 280° C., at least about 290° C., at least about 300° C., at least about 320° C., or at least about 340° C., inclusive. In some embodiments, the temperature sensitive label can record a temperature of no more than about 350° C., no more than about 340° C., no more than about 320° C., no more than about 300° C., no more than about 290° C., no more than about 280° C., no more than about 270° C., no more than about 260° C., no more than about 250° C., no more than about 240° C., no more than about 230° C., no more than about 220° C., no more than about 210° C., or no more than about 200° C., no more than about 190° C., no more than about 180° C., no more than about 170° C., no more than about 160° C., no more than about 150° C., no more than about 140° C., no more than about 130° C., no more than about 120° C., no more than about 110° C., no more than about 100° C., or no more than about 90° C., no more than about 80° C., no more than about 70° C., no more than about 60° C., no more than about 50° C., no more than about 40° C., or no more than about 30° C., inclusive. Combinations of the above-referenced temperatures are also possible (e.g. at least about 30° C., and no more than about 300° C., or at least about 100° C. and no more than about 200° C.). In some embodiments, the temperature sensitive label can record the temperature of about 30° C., about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., or about 300° C., inclusive.

In some embodiments, the temperature sensitive label can have a response time of about 1 s to about 10 s, inclusive of all values and ranges therebetween. For example, in some embodiments, the temperature sensitive label can have a response time of at least about 1 s, at least about 2 s, at least about 3 s, at least about 4 s, at least about 5 s, at least about 6 s, at least about 7 s, at least about 8 s, at least about 9 s, or at least about 10 s, inclusive. In some embodiments, the temperature sensitive label can have a response time of no more than about 10 s, no more than about 9 s, no more than about 8 s, no more than about 7 s, no more than about 6 s, no more than about 5 s, no more than about 4 s, no more than about 3 s, no more than about 2 s, or no more than about 1 s, inclusive. Combinations of the above-referenced response times are also possible (e.g. at least about 1 s, and no more than about 10 s, or at least about 2 s and no more than about 8 s). In some embodiments, the temperature sensitive label can have a response time of about 1 s, about 2 s, about 3 s, about 4 s, about 5 s, about 6 s, about 7 s, about 8 s, about 9 s, or about 10 s, inclusive. Without being bound by theory, the accuracy of temperature sensitive label can vary with temperature. For example, the temperature sensitive label can have an accuracy of about ±1° C. at temperatures below about 100° C. In some embodiments, the temperature sensitive label can have an accuracy of about ±1.5° C. at temperatures between about 100° C. and about 155° C. In some embodiments, the temperature sensitive label can have an accuracy of about ±4° C. at temperatures above about 155° C.

In some embodiments, the temperature sensitive label can include a series of temperature sensitive elements, each configured to undergo an irreversible color change at a distinct temperature threshold. This format of temperature sensitive label can change color when the surface reaches or exceeds different temperature thresholds, irreversibly. This can allow recording a range of thermal exposures and provide a visual indication of the highest temperature experienced by the component to which it is affixed.

For example, the temperature-sensitive label can be a SPOTSEE THERMAX® temperature indicator labeled coupled to the encapsulation layer 114 or the core 112, configured to trace maximum thermal exposure during operation. In some embodiments, the temperature-sensitive label can provide a permanent visual record of the highest temperature of the surface of the encapsulation layer 114 or the core 112. For example, the temperature-sensitive label can be a six-level format which may include temperature indicators for 100° C., 110° C., 120° C., 130° C., 140° C., and 150° C. For example, when the temperature reaches 130° C., the first four elements will turn black while the last two remain unchanged. The temperature sensitive label can provide a clear visual record of the maximum temperature exposure.

In some embodiments, the traceability feature 160 may include one or more RFID tags that are readable by, or communicable with, a scan engine that manages each RFID tag and its antenna. In some embodiments, conductors 102 can include multiple RFID tags. In some embodiments, the RFID tag reads or data can be stored and manipulated within an offsite database including but not limited to manufacturing data, installation information, life cycle data, and/or usage history. In some embodiments, a software graphical user interface can be used to display data from the offsite database.

In some embodiments, the traceability feature 160 is detectable via a non-destructible detection method, such as by using a radiative energy having a wavelength configured to penetrate through the conductor layer to detect the traceability feature 160. For example, the traceability feature 160 may be configured to be detectible via X-rays, ultrasound waves, or infrared waves. In some embodiments, the radiative energy may be configured to penetrate through the conductor layer 120 to interact with the traceability feature 160. For example, in some embodiments, the radiative energy may be configured to interact with the traceability feature 160 to identify a characteristic of the traceability feature 160.

In some embodiments, the traceability feature 160 includes a security feature (not shown) such as an overt (visible) security feature, a semi-covert security feature (i.e., detectable via a single detection method), or a covert security feature (i.e., detectable via a combination of detection methods). In some embodiments, security feature may include a hologram or a holographic image. In some embodiments, the traceability feature 160 includes a security feature, such as a feature visible only via exposure to a particular wavelength of electromagnetic radiation. For example, the traceability feature 160 may include a fluorescent particle, fluorescent pigment, or a fluorescent taggant. The fluorescent particle, pigment, or taggant may be excited via exposure to an irradiation source having a predetermined excitation wavelength. For example, the predetermined excitation wavelength may be any suitable wavelength in the electromagnetic spectrum, such as an ultraviolet (UV) light (e.g., light with wavelength in the range of about 10 nm to about 400 nm) or infrared (IR) light (e.g., light with wavelength in the near-IR range of about 700 nm to about 5 micron). In some embodiments, the traceability feature 160 may include a fluorescent particle incorporated in the strength member 110.

Although a single traceability feature 160 is shown in FIG. 1, in some embodiments the strength member 110 may include a plurality of traceability features (not shown), each of which may be substantially similar to the traceability feature 160. In some embodiments, the plurality of traceability features may be incorporated in the encapsulation layer 114, the core 112, or a combination thereof. In some embodiments, the plurality of traceability features may be axially disposed along a portion of a length of the conductor 102, circumferentially disposed around a portion of a circumference of the conductor 102, or a combination thereof. In some embodiments, the plurality of traceability features may be arranged in a repeating pattern. In some embodiments, the plurality of traceability features may be arranged randomly. In some embodiments, the plurality of traceability features may include a plurality of identical, or nearly identical, traceability features, which are indistinguishable from each other. In some embodiments, the plurality of traceability features may include variations in size, color, groove number, groove depth, shape, position relative to an end of the conductor, orientation (i.e., rotation) relative to the length of the conductor, or a combination thereof. In some embodiments, the plurality of traceability features may be formed via different means (e.g., engraving, laser marking, etc.).

The conductor layer 120 is disposed around the strength member 110 and configured to transmit electrical signals therethrough at an operating temperature. For example, the operating temperature of the conductor layer 120 may be in a range of about 20 degrees to about 250 degrees Celsius, inclusive (e.g., 20, 30, 40, 50, 60, 70, 80, 90, 100, 110, 120, 130, 140, 150, 160, 170, 180, 190, 200, 210, 220, 230, 240, or 250 degrees Celsius, inclusive). Since the traceability feature 160 is incorporated in the strength member 110, and the conductor layer 120 is disposed around the strength member 110, the traceability feature 160 is disposed beneath the conductor layer 120. Thus, the conductor layer 120 protects the traceability feature 160 from degradation by shielding the traceability feature 160 from oxidation, moisture plasticization, solar radiation, corrosion, and environmental degradation.

In some embodiments, the conductor layer 120 may include a plurality of strands of a conductive material disposed around the strength member 110. For example, the conductor layer 120 may include a first set of conductive strands disposed around the strength member 110 in a first wound direction (e.g., wound helically around the strength member 110 in a first rotational direction), a second set of conductive strands disposed around the first set of strands in a second wound direction (e.g., wound helically around the first set of conductive strands in a second rotational direction opposite the first rotational direction), and may also include a third set of strands wound around the second set of strands in the first wound direction, and may further include any number of additional strands as desired.

In some embodiments, the conductor layer 120 (e.g., a plurality of strands of conductive material) may include, for example, aluminum, aluminum alloy, copper or copper alloy including micro alloy as conductive media, etc. In some embodiments, the conductor layer 120 may include conductive strands including Z, C or S wires to keep the outer strands in place. The conductor layer 120 may have any suitable cross-sectional shape, for example, circular, triangular, trapezoidal, etc. In some embodiments, the conductor layer 120 may include a stranded aluminum layer that may be round or trapezoidal. In some embodiments, the conductor layer 120 may include Z shaped aluminum strands. In some embodiments, the conductor layer 120 may include S shaped aluminum strands. In some embodiment, the conductor 102 may include any of the conductors described in U.S. Pat. No. 9,633,766, filed Sep. 23, 2015, and entitled “Energy Efficient Conductors with Reduced Thermal Knee Points and the Method of Manufacture Thereof,” the entire disclosure of which is incorporated herein by reference.

In some embodiments, the strength member 110 may be adequately tensioned while the conductor layer 120 of aluminum or copper or their respective alloys disposed around the strength member 110 may be applied to cause the conductor 102 to form a cohesive conductive hybrid rod that is spoolable onto a conductor reel. In some embodiments, to facilitate conductor spooling onto a reel and conductor spring back at ease, the conductor 102 may be optionally configured to be non-round (e.g., elliptical) such that the shorter axis (in conductor 102) is subjected to bending around a spool (or a sheaves wheel during conductor installation) to facilitate a smaller bend or spool radius, while the strength members 110 may be configured to have a longer axis to facilitate spring back for installation. The overall conductor 102 may be round with non-round strength member 110 or multiple strength members 110 arranged to be non-round, and the spooling bending direction may be along the long axis of the strength member 110 to facilitate spring back while not overly subjecting the conductor layer 120 with additional compressive force from spooling bending.

To further facilitate spooling of the conductor layer 120 on the strength member 110, in some embodiments, the conductor layer 120 may include multiple segments. For example, in some embodiments, the conductor layer 120 may include multiple segments, such as strands or sets of strands or wires of conductive material (e.g., 2, 3, 4 etc.). In some embodiments, each segment may be bonded to strength member 110 while retaining compressive stress. In some embodiments, each segment rotates one full rotation or more along the conductor 102 length (equal to one full spool in a reel) to facilitate easy spooling. Thus, the conductor 102 may be configured to have negligible skin effect (i.e., conducting layer thickness is less than the skin depth required at AC circuit frequency), with the strength member 110 may be under sufficient residual tensile stress, and the conductor layer 120 (e.g., each of the strands of the conductive material) are mostly free of tension or under compressive stress. In some embodiments, the strands of the conductive material may be formed from a conforming machine, for example, by extruding hot deformable (e.g., semi solid) conductive material (e.g., aluminum) from a mold. The strands can be molded to be round or trapezoidal. In some embodiments, the extrusion mold or die may have a stranding lay ratio defined therein so that during the stranding operation of the conductive strands, no shaping may be needed (e.g., removing of sharp corners or edges of the conductive strands to avoid corona as is performed in conventional stranding operations). In some embodiments, the conductive media may be extruded out of the mold or die at an angle so as to form conductive strands that wrap around the strength member 110 at an angle, as described herein.

In some embodiments, for AC applications where skin effect is prominent, the conductor layer 120 may include a plurality of layers of conductive strands disposed concentrically around the strength member 110. In some embodiments, each layer of the plurality of layers may be of finite thickness to maximize skin effect for lowest AC resistance at minimal conductor content. In some embodiments, the conductor layer 120 may be optionally stranded to facilitate conductor spooling around a reasonably sized spool and facilitate conductor stringing. In some embodiments, the outer most strands included in the conductor layer 120 may be TW, C, Z, S, or round strands if more aluminum or copper are used, as it will not cause permanent bird caging problem (i.e., the inner strands of the conductor layer 120 may not be deformed such that they prevent the outer strands from proper resettlement after tension is released or reduced). Accordingly, the smooth outer surface and the compact configuration can effectively reduce the wind load and ice accumulation on the conductor 102, resulting in less sag from ice or wind related weather events.

In some embodiments, the conductor 102 may be pre-stressed, for example, by subjecting the conformed conductor 102 to a paired tensioner approach or trimming the predetermined core 112 length before dead-ending, all accomplished without exerting the high tensile stress to the pole arms to pre-tension conventional conductors in the electric poles. For example, the conductor 102 may be subjected to pre-tensioning treatment using sets of bull wheels prior to the first sheave wheel during stringing operation, without exerting additional load to the electric towers. This can, for example, be accomplished by two sets of tensioners, with the first set maintaining normal back tension to the conductor drum/reel, while the second set restoring the normal stringing tension to avoid excessive load to electric poles or towers, for example, old towers in reconductoring projects.

The conductor 102 may be subjected to a pre-tensioning stress between the first and second tensioners. For example, in some embodiments, the pre-tensioning stress may be about 2 times greater than an average conductor tensile load to ensure that the pre-tensioning is driving its knee point below the normal operating temperature such that conductor layer 120 is not in tension for optimal self-damping and/or the conductor 102 substantially does not change its sag with temperature. In some embodiments, the conductor layer 120 (e.g., each strand of conductive material included in the conductor layer 120) may include aluminum having electrical conductivity of at least 50% of the International Annealed Copper Standard (IACS), e.g., at least 50% IACS. In some embodiments, the conductor layer 120 may include aluminum having an electrical conductivity of at least 55% IACS, at least 60% IACS, or at least 65% IACS, or may include copper having electrical conductivity of at least 65% IACS, at least 75% IACS, or even at least 95% IACS, inclusive of all values and ranges therebetween.

The conductor 102 may combine pre-tensioning with strength member 110 that may include an encapsulation layer 114 formed of a conductive material of sufficient compressive strength and thickness to substantially preserve the pre-tensioning stress in the strength member 110, while rendering the conductor layer 120 disposed around the strength member 110 mostly tension free or in compression after conductor field installation, and preserving the low thermal expansion characteristics of the strength member 110. The conductor 102 may have an inherently lower thermal knee point. Unlike gap conductors requiring complicated installation tools and process, where the conductor, fitting, installation, and repair are very expensive, the conductor 102 may be easy to install and repair, while maintaining low sag, high capacity, and energy efficiency as a result of knee point shift.

In some embodiments, metallurgical bonding may be provided between the strength member 110 and the conductor layer 120. In some embodiments, adhesives (e.g., Chemlok 250 from Lord Corp) may be applied to the surface of the strength member 110 of the conductor 102 to further promote the adhesion between the strength member 110 and the conductor layer 120 disposed thereon. Additionally, surface features on the strength member 110 may be incorporated to promote interlocking between the conductor layer 120 and the strength member 110 (e.g., stranded strength member 110 such as multi-strand composite cores in C⁷ or steel wires in conventional conductors; pultruded composite core with protruding or depleting surface features; and an intentional rough surface on strength members such as ACCC core from CTC Global where a single or multiple strand glass or basalt or similar and other types of insulating material were disposed around the strength member 110, instead of just longitudinally parallel configuration described patent). In some embodiments, the conductor layer 120 may include aluminum, aluminum alloy, copper and copper alloys, lead, tin, indium tin oxide, silver, gold, non-metallic materials with conductive particles, any other conductive material, conductive alloy, or conductive composite, or combination thereof.

It should be appreciated that, the conductor layer 120 may be under no substantial tension while the strength member 110 may be pre-stretched/tensioned. After the pre-tension in the strength member 110 is released, the conductor layer 120 may be subjected to compression, which may minimize the shrinking back of the strength member 110. The strength member 110 made with composite materials may have a strength above 80 ksi, and a modulus ranging from 5 msi to 40 msi, and a CTE of about 1×10⁻⁶/° C. to about 8×10⁻⁶/° C., inclusive.

The level of pre-tensioning in the conductor 102 may be dependent on conductor size, conductor configuration, conductor application environment and the desirable target thermal knee point. If the goal is to have a conductor thermal knee point at or near the stringing temperature (e.g., ambient), the tension desired onto the strength member 110 may only be about the same stringing sag tension (e.g., about 10% to about 20%, inclusive, of rated conductor strength), plus about 5% to about 50%, inclusive, of the stringing sag tension level (e.g., about 10% to about 30%, inclusive) extra to keep all aluminum included in the conductor layer 120 (or copper in the case of copper conductors) free of tension after stringing, which is significantly lower compared to conductor pre-tensioning in the electric towers where a load about 40% of conductor tensile strength are commonly used. If lower thermal knee point is desired, higher pre-tensioning stress may be used. It is also important to note that the composite core 112 of the strength member 110 may include carbon fibers that are strong, light weight, and have low thermal sag. The encapsulated strength member 110 using fiber reinforced composite materials may be particularly advantageous where the elastic strength member 110 facilitates spring back of the encapsulated strength member 110 from the reeled configuration for field installation. In some embodiments, the strength member 110 may be pre-strained by at least 0.05% (e.g, at least 0.05%, at least 0.1%, at least 0.15%, at least 0.2%, at least 0.25, or at least 0.3%, inclusive).

In some embodiments, for example, for AC transmission applications, the conductor layer 120 may include concentric layers (e.g., strands) of conductive media disposed around the strength member 110 during a conforming process. The skin depth may be adjusted based on transmission frequency. In some embodiments, the skin depth may be in a range of about 6 mm to about 12 mm, inclusive, at 60 Hz. For example, in some embodiments, the skin depth of the conductor layer 120 at 60 Hz may be about 6 mm, about 7 mm, about 8 mm, about 9 mm, about 10 mm, about 11 mm, or about 12 mm, inclusive of all values and ranges therebetween. In some embodiments, the skin depth may be in a range of about 12 mm to about 20 mm, inclusive, at 25 Hz (e.g., 12, 13, 14, or 15 mm, inclusive) for pure copper. For pure aluminum, the skin depth may be in a range of about 9 mm to about 14 mm, inclusive at 25 Hz (e.g., 9, 10, 11, 12, 13, or 14 mm, inclusive) and in a range of about 14 mm to about 20 mm at 60 Hz (e.g., 14, 15, 16, 17, 18, 19, or 20 mm, inclusive).

A thickness of each strand of conductive media included in the conductor layer 120 may be less than the maximum allowable depth, for example, to achieve low A/C resistance. In some embodiments, each of the conductive strands included in the conductor layer 120 may include copper having a thickness of up to 12 mm (e.g., up to 12, up to 11, up to 10, up to 9, or up to 8 mm, inclusive). In some embodiments, each of the conductive strands included in the conductor layer 120 may include aluminum having a thickness of up to 16 mm (e.g., up to 16, up to 14, up to 13, up to 12, up to 11, or up to 10 mm, inclusive). In some embodiments, a dielectric coating may be interposed between the conductive strands to optimize for the skin effect. In some embodiments, lubricants may be provided between adjacent conductive strands to facilitate some relative motion of the conductive strands included in the conductor layer 120.

In some embodiments, an interface between the strength member 110 and the conductor layer 120 may be further optimized with surface features in the strength member 110 enhancing interfacial locking and/or bonding between the strength member 110 and the conductor layer 120 to retain and preserve the stress from pre-tensioning. Such features may include but are not limited to protruded features on an outer surface of the strength member 110 (e.g., and outer surface of the encapsulation layer 114 of the inner coating 116) as well as rotation of the strength member 110 around the axial direction. Furthermore, the same features can be incorporated into the interface between subsequent conductive strands included in the conductor layer 120. In some embodiments, the strength member 110 may include a glass fiber tow disposed around its surface to create a screw shape or twisted surface. In some embodiments, a braided or woven fiber layer is applied in the outer layer of the strength member 110 to promote interlocking or bonding between strength member 110 and the conductor layer 120. Steel wires may be shaped with similar surface features. In some embodiments, the strength member 110 may be pretensioned by pre-tensioning the reinforcement fibers in a matrix of conductive media such as aluminum or copper or their respective alloys. Such reinforcement fibers may include ceramic fibers, non-metallic fibers, carbon fibers, glass fibers, and/or others of similar types.

In some embodiments, an insulating layer 122 (e.g., a jacket) may optionally be disposed around the conductor layer 120. The insulating layer 122 may be formed from any suitable electrically insulative material, for example, rubber, plastics, or polymers (e.g., polyethylene, PTFE, high density polyethylene, cross-linked high density polyethylene, etc.). The insulating layer 122 may be configured to electrically isolate or shield the conductor 102. In some embodiments, the insulating layer 122 may be excluded.

In some embodiments, an outer surface of the conductor layer 120 (e.g., outer surface of the outermost conductive strands or an outer surface of each of the conductive strands) or the insulating layer 122 is treated with features and/or include features to cause the outer surface to have a solar absorptivity of less than 0.6 (e.g., less than 0.55, less than 0.5, less than 0.45, less than 0.4, less than 0.35, less than 0.3, less than 0.25, less than 0.2, less than 0.15, or less than 0.1, inclusive). In some embodiments, the outer surface has a solar absorptivity of less than 0.55.

In some embodiments, to reduce the operating temperature of the conductor 102, the conductor 102 may also include an outer coating 130 disposed on the conductor layer 120. In some embodiments, the outer coating 130 may include any of the outer coatings as described in detail in the '721 incorporated by reference herein in its entirety.

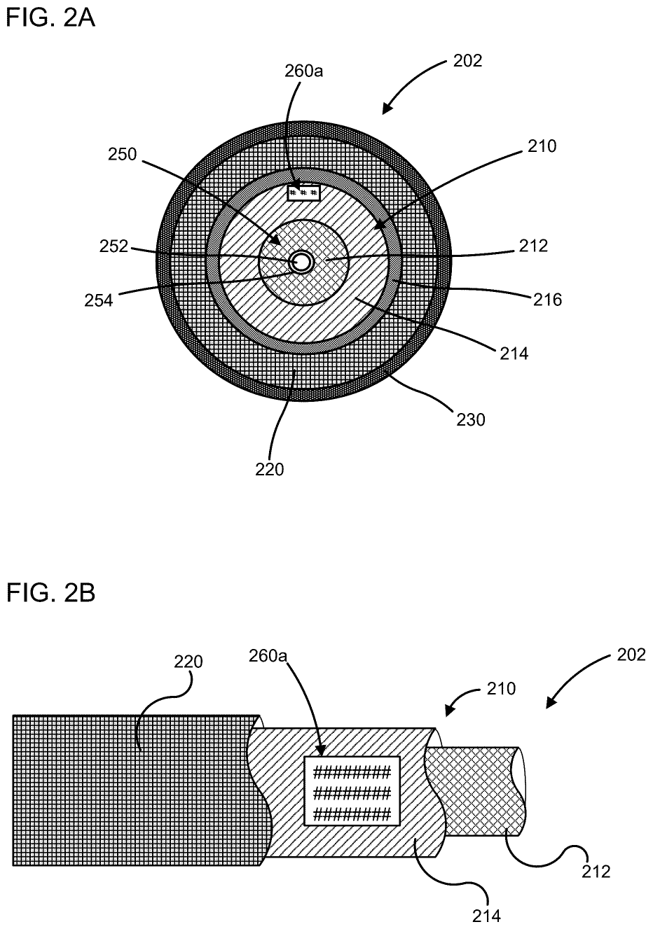

FIG. 2A is a front cross-sectional view of a conductor 202 that may be used as the conductor(s) in the assembly 100, according to an embodiment. The conductor 202 includes a strength member 210 including a core 212, an encapsulation layer 214 disposed around the core 212, a traceability feature 260a incorporated in the encapsulation layer 214. Optionally, an optical fiber assembly 250 may be disposed in the core 212. The conductor 202 also includes a conductor layer 220 and may also optionally include an outer coating 230 and an optional insulating layer (not shown) disposed between the conductor layer 220 and the outer coating 230. The conductor 202 may be used in grid transmission applications to conduct electricity. FIG. 2B is a side perspective view of the conductor 202 with a portion proximate to an axial end of the conductor layer 220 removed to reveal the traceability feature 260a formed or incorporated in the encapsulation layer 214, and a portion of the encapsulation layer 214 proximate to its axial end removed to reveal the core 212 disposed therewithin.

The core 212 may be formed from a composite material. In some embodiments, the composite material may include nonmetallic fiber reinforced metal matrix composite, carbon fiber reinforced composite of either thermoplastic or thermoset matrix, or composites reinforced with other types of fibers such as quartz, AR-Glass, E-Glass, S-Glass, H-Glass, silicon carbide, silicon nitride, alumina, basalt fibers, especially formulated silica fibers, any other suitable composite material, or any combination thereof. The encapsulation layer 214 is disposed circumferentially around the core 212. The encapsulation layer 214 may be formed from any suitable electrically conductive or non-conductive material. While shown as including a single encapsulation layer 214, in some embodiments, multiple encapsulation layers 214 may be disposed on the core 212. In some embodiments, the core 212 and the encapsulation layer 214 may be substantially similar to the core 112 and the encapsulation layer 114 described herein. Thus, various features of the core 212 and the encapsulation layer 214 are not described in further detail herein.

In some embodiments, the strength member 210 may have a minimum level of tensile strength, for example, at least 600 MPa (e.g., at least 600, at least 700, at least 800, at least 1,000, at least 1,200, at least 1,400, at least 1,600, at least 1,800, or at least 2,000 MPa, inclusive). In some embodiments, the strength member 210 may be substantially similar to the strength member 110 and may be formed from any suitable material or formed using any suitable mechanism or method as described with respect to the strength member 110.

In some embodiments, the conductor 202 may include the outer coating 230 that is formulated to have a high radiative emissivity in the 2.5 microns to 15 microns wavelength, inclusive, of the solar radiation. While this may cause cooling of the conductor layer 220, the radiated heat will also travel towards the strength member 210 and cause heating of the core 212, for example, cause the core 212 to be at a higher operating temperature than the conductor layer 220, which is undesirable. In some embodiments in which there is no stranded layer of conductive materials around the encapsulation layer 214, the outer surface of the encapsulation layer 214 (e.g., an inner coating 216 disposed thereon) may be configured for high radiative emissivity to remove heat from conductor 202 through thermal radiation.

The traceability feature 260 is incorporated in the strength member 210, such as, for example, incorporated in at least one of the core 212 or the encapsulation layer 214, as shown in FIG. 2A. The traceability feature 260 may be substantially similar to the traceability feature 160 and may be formed using any suitable mechanism or method as described with respect to the traceability feature 160. Thus, certain features of the traceability feature 260 are not described in further detail herein.

The conductor layer 220 is disposed around the strength member 210 and configured to transmit electrical signals therethrough at an operating temperature in a range of about 20 degrees to about 250 degrees Celsius, inclusive (e.g., 20, 30, 40, 50, 60, 70, 80, 90, 100, 110, 120, 130, 140, 150, 160, 170, 180, 190, 200, 210, 220, 230, 240, or 250 degrees Celsius, inclusive). In some embodiments, the conductor layer 220 may be disposed around the strength member 210 such that the traceability feature 260 is disposed beneath the conductor layer 220 such that the conductor layer 220 shields the traceability features 260 from oxidation, moisture plasticization, solar radiation, corrosion, and/or environmental degradation. The conductor layer 220 may be substantially similar to the conductor layer 120 and may be formed from any suitable material or with any method or process as described with respect to the conductor layer 120, and, therefore, not described in further detail herein.

In some embodiments, an insulating layer (not shown) (e.g., a jacket) may be disposed around the conductor layer 220. The insulating layer may be formed from any suitable electrically insulative material, for example, rubber, plastics, or polymers (e.g., polyethylene, high density polyethylene, cross-linked high density polyethylene, PTFE, etc.). The insulating layer (not shown) may be configured to electrically isolate or shield the conductor 202. In some embodiments, the insulating layer (not shown) may be excluded.

In some embodiments, the outer coating 230 may be disposed on an outer surface of the conductor layer 220, for example, around individual strands that form the conductor layer 220, or only on outer surface of the outer most conductive strands of the conductor layer 220. The outer coating 230 may be substantially similar to the outer coating 130 and is, therefore, not described in further detail herein.

In some embodiment, the optical fiber assembly 250 may be disposed in the core 212 and includes a fiber core 252 and a fiber encapsulation layer disposed around the fiber core 252. The optical fiber assembly 250 may be substantially similar to optical fiber assembly 150. In some embodiments, the fiber encapsulation layer 254 may have a thickness T (not shown) in a range of about 0.125 mm to about 0.5 mm, inclusive (e.g., 0.125, 0.15, 0.15, 0.1, 0.15, 0.2, 0.25, 0.3, 0.35, 0.4, 0.45, or 0.5 mm, inclusive). In some embodiments, the thickness T of the fiber encapsulation layer 254 and/or the thickness thereof may be sufficient to withstand the extrusion or pultrusion process used to form the core 252 or otherwise, the strength member 210. As shown in FIG. 2, the optical fiber assembly 250 may be axially aligned with a central axis (or longitudinal axis) of the core 212, for example, to reduce micro-bending stresses on the optical fiber assembly 250. In other embodiments, the optical fiber assembly 250 may be disposed offset from the central axis, for example, disposed proximate to an outer periphery of the core 212.

FIG. 2C is a front cross-sectional view of the conductor 202 coupled to a support assembly 270, according to an embodiment. FIG. 2D is a side perspective view of the conductor 202 with a portion proximate to an axial end of the conductor layer 220 removed and coupled to the support assembly 270, according to an embodiment. As shown in FIGS. 2C-2D a first traceability feature 260a may be incorporated in the encapsulation layer, and a second traceability feature 260b may be included in the support assembly 270. In some embodiments, one of the first traceability feature 260a or the second traceability feature 260b may be excluded. The traceability features 260a, 260b, and the support assembly 270 may be substantially similar to the traceability feature 160 and the support assembly 170 as described with respect to FIG. 1 and therefore, not described in further detail herein.

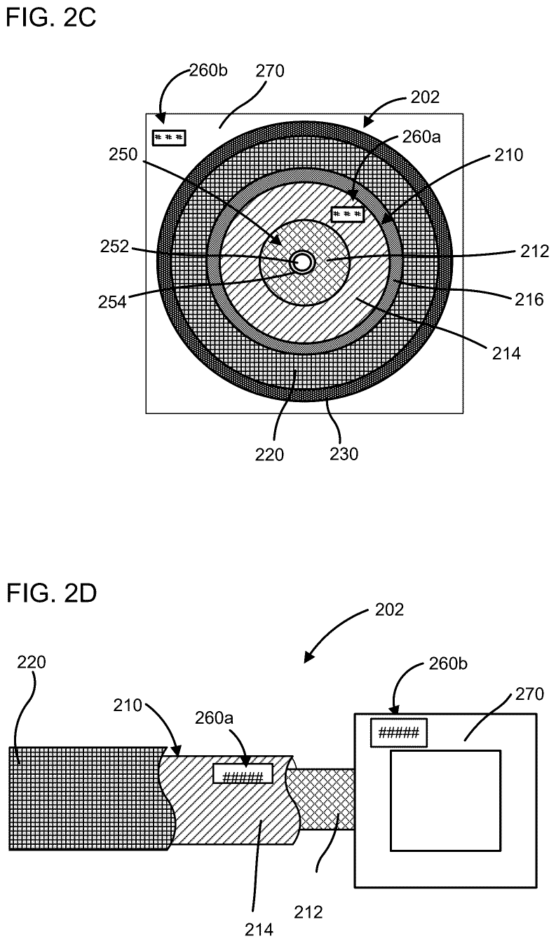

FIG. 3 is an example of a traceability feature 360 that may be used as the traceability feature 160, 260 in the conductor 102, 202 according to an embodiment. In some embodiments, the traceability feature 360 may include an alphanumeric character 362, a barcode 364, a symbol 366, and/or a boundary 368. In some embodiments, the traceability feature 360 may include a quick-response (QR) code (not shown). In some embodiments, the alphanumeric character 362 may include a plurality of alphanumeric characters, for example, any suitable combination of alphanumeric characters. In some embodiments, the alphanumeric character 362, the barcode 364, or the quick-response (QR) code may provide information to a user, such as a serial number, a product number, a purchase order number, a work order number, a date of installation, any other information important for tracking the conductor, or a combination thereof. The traceability feature 360 may be substantially similar to the traceability feature 160 and may be formed from any suitable method or process as described with respect to the traceability feature 160, and, therefore, certain features of the traceability feature 360 are not described in further detail herein.

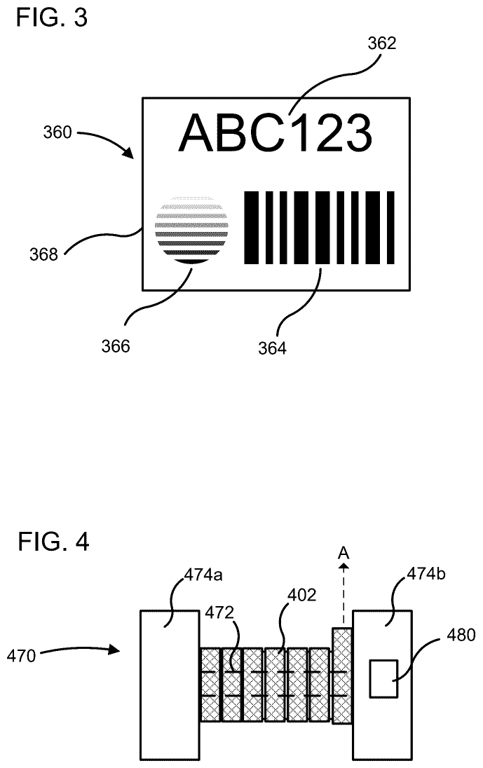

In some embodiments, a conductor may be wrapped around a spool for storage and transportation, and the spool or any other carrier in which the conductor is disposed may include a tracking device or feature. For example, FIG. 4 is an illustration of spool 470 with a conductor 402 wrapped around a portion thereof, according to an embodiment. The spool 470 may include a cylindrical rod 472 around which the conductor 402 is wrapped. The conductor 402 may be substantially similar to the conductor 102 or 202 and therefore, not described in further detail herein. In some embodiments, the rod 472 may be solid. In some embodiments, the rod 472 may be hollow, for example, to facilitate mounting on corresponding pins or a rod to allow spinning or rotation of the spool 470 for wrapping the conductor 402 therearound, or removing a length of the conductor 402 from the spool 470 (e.g., by pulling on an axial end of the conductor 402 in the direction shown by the arrow A in FIG. 4). The spool 470 may also include rims 474a, 474b (collectively referred to herein as “rims 474”) disposed at axial ends of the rod 472. The rims 474 have a substantially larger diameter relative to a diameter of the rod 472 and facilitate securing of the conductor 402 on the rod 472 by inhibiting the conductor 402 from sliding off the axial edges of the rod 472.

While the conductor 402 may include a traceability feature (e.g., the traceability feature 160, 260, 360), it may also be beneficial to track movement and/or location of the spool 470 with the conductor 402 disposed thereon, for example, as the spool 470 is delivered from a manufacturing facility to a storage facility, then to an installation location, and so on. In some embodiments, the spool 470 may include a tracking device 480, for example, a global positioning system (GPS) tracker (e.g., an AIRTAG®, TILE MATER, etc.). The tracking device 480 may be disposed in any suitable location on the spool 470, for example, disposed on or within one of the rims 474, or the rod 472. In some embodiments, the tracking device 480 may be coupled to the spool 470 (e.g., to the rim 474a or 474b) via a clip, a fastener (e.g., a screw, a nut, a bolt, a rivet, etc.), or bonded thereto (e.g., via an adhesive). In some embodiments, the tracking device 480 may be embedded in the spool 470 at any suitable location. In some embodiments, the tracking device 480 may be disposed in a cavity formed or defined in the rim 474a or 474b. In some embodiments, the cavity may be closed by a cover (not shown) that may be sealed (e.g., via welding or bonding) such that the tracking device 480 is irremovably disposed in the spool 470, or may be a removable cover to allow the tracking device 480 to be removed therefrom (e.g., for replacement). In some embodiments, the tracking device 480 may include or be provided with tamper resistant features (e.g., a seal which breaks if an attempt at removing or tampering with the tracking device 480 is made) to indicate to a user if the tracking device 480 is tampered with. The tracking device 480 may be configured to generate a signal indicative of a location of the spool 470 and thereby, the conductor 402 so as to allow the user to track the spool 470 by determining its current location.

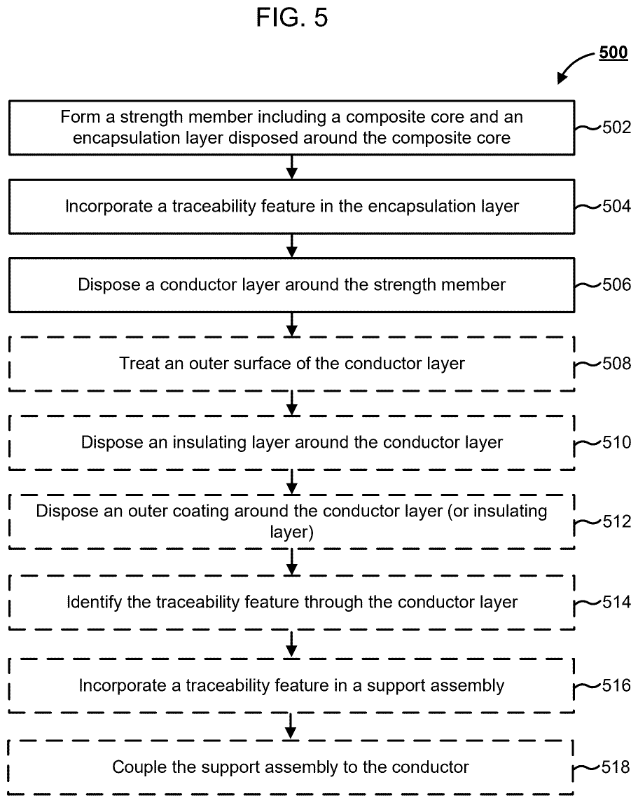

FIG. 5 is a schematic flow chart of a method 500 for forming a conductor (e.g., the conductor 102 or 202 as previously described) with a traceability feature (e.g., 160, 260, or 360 as previously described). While described with respect to the conductor 102, the operations of method 500 can be used to form any conductor 102 having a traceability feature 160. All such implementations are envisioned and should be considered to be within the scope of the present disclosure.

The method 500 includes forming a strength member 110 including a composite core 112 and an encapsulation layer 114, at 502. At 504, a traceability feature 160 is incorporated in the encapsulation layer 114. In some embodiments, the traceability feature 160 may be formed on an outer surface of the encapsulation layer 114. In some embodiments, the traceability feature 160 may be incorporated or formed in the encapsulation layer 114 by, for example, laser marking, laser etching, laser engraving, mechanical engraving, intaglio printing, stamping, or any suitable combination thereof.

In some embodiments, laser marking, laser etching, or laser engraving may be employed to form the traceability feature 160. In such a case, any laser, or any laser system, configured for marking objects may be employed to incorporate the traceability feature 160 in the encapsulation layer 114, and, hence, the laser or laser system should not be limited to specific laser systems or laser parameters. In some embodiments, a 2D laser or a 3D laser may be employed to form the traceability feature 160. In some embodiments, a laser parameter (or a laser system parameter), such as a wavelength, a laser power, a pulse duration, a pulse repetition rate, a beam diameter, a polarization, a coherence length, a beam profile, a spot size, a working distance, etc., may be adjusted or optimized to form the traceability feature 160. In some embodiments, a laser having a laser power of about 1 W to about 100 W, inclusive (e.g., 1 W, 10 W, 20 W, 30 W, 40 W, 50 W, 60 W, 70 W, 80 W, 90 W, 100 W, inclusive), may be employed for forming the traceability feature 160. In some embodiments, the laser power may be above 40 W, (e.g., 50 W, 60 W, 70 W, 80 W, 90 W, 100 W, inclusive). In some embodiments, a laser parameter (or a laser system parameter), such as a wavelength, a laser power, a pulse duration, a pulse repetition rate, a beam diameter, a polarization, a coherence length, a beam profile, a spot size, a working distance, etc.) may be adjusted or optimized to incorporate the traceability feature 160 in the encapsulation layer 114 such that the traceability feature 160 is clearly visible in the encapsulation layer 114. In some embodiments, the traceability feature 160 may additionally, or alternatively, be disposed on an outer surface of the encapsulation layer 114 via laser marking, laser etching, or laser engraving.

Although not shown in FIG. 5, in some embodiments, the method 500 may include treating an outer surface of the encapsulation layer 114 with a surface treatment or an inner coating 116, as previously described with respect to FIG. 1. The inner coating 116 may be formed from any suitable material or with any suitable method or process as previously described with respect to FIG. 1, and, therefore, is not described in further detail herein.

The method 500 further includes disposing a conductor layer 120 around the strength member 110, at 506. In some embodiments, the traceability feature 160 may be formed prior to, or during, the process of disposing the conductor layer 120 around the strength member 110. The conductor layer 120 may be formed from any suitable material, method, or process as previously described with respect to FIG. 1, and, therefore, is not described in further detail herein.

In some embodiments, the method 500 may include treating an outer surface of the conductor layer 120, at 508. In some embodiments, the treatment may include disposing the inner coating 116 and/or the outer coating 130, which may be formed from any suitable material or with any suitable method or process as previously described with respect to the inner coating 116 or the outer coating 130 of FIG. 1.

In some embodiments, the method 500 may include disposing an insulating layer 122 around the conductor layer 120, at 510. The insulating layer 122 may be formed from any suitable material or with any suitable method or process as previously described with respect to the insulating layer 122 of FIG. 1.

In some embodiments, the method 500 may include disposing an outer coating 130 around the conductor layer 120 (or insulating layer 122), at 512. In some embodiments, the method 500 may also include identifying the traceability feature 160 through the conductor layer 120 using a radiative energy, at 514. For example, in some embodiments, the radiative energy may be configured to penetrate through the conductor layer 120 to the traceability feature 160 such that it may interact with the traceability feature 160 and/or identify a characteristic of the traceability feature 160. In some embodiments, the method 500 may include incorporating the traceability feature 160b in the support assembly 170 (e.g., a dead-end coupler, a splice coupler, or a suspension clamp), at 516 as previously described herein. In some embodiments, the support assembly 170 may be coupled to the conductor 102, at 518 as previously described herein. In some embodiments, the support assembly 170 may exclude the traceability feature 160b. In such implementations, operation 516 may be excluded.

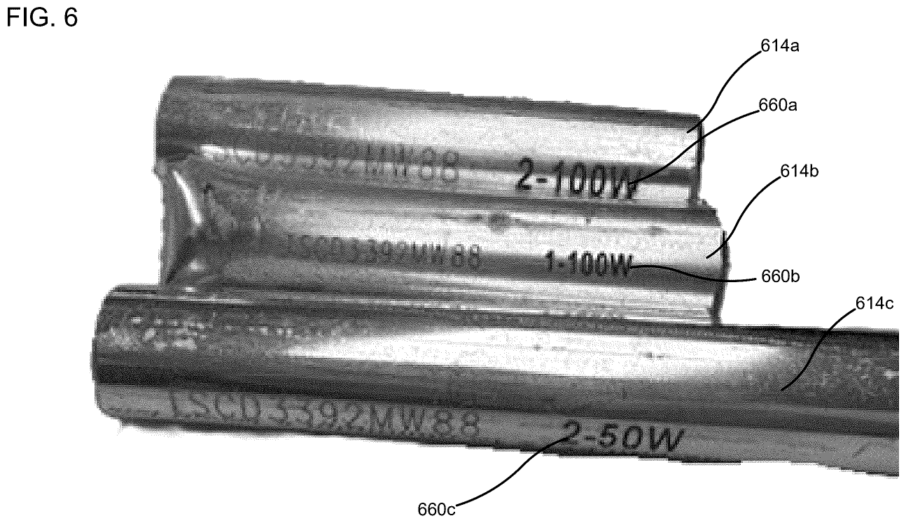

FIG. 6 illustrates a plurality of encapsulation layers 614a, 614b, 614c (collectively referred herein as “encapsulation layers 614”), each including a corresponding traceability feature 660a, 660b, 660c (collectively referred to as “traceability features 660”), respectively defined therein, according to an embodiment. In some embodiments, the encapsulation layers 614a, 614b, 614c may be referred to as “first encapsulation layer 614a”, “second encapsulation layer 614b”, and “third encapsulation layer 614c”, respectively. Likewise, in some embodiments, the traceability features 660a, 660b, 660c may be referred to as “first traceability feature 660a”, “second traceability feature 660b”, and “third traceability feature 660c”, respectively. In some embodiments, the encapsulation layers 614 and the traceability features 660 may be incorporated in the assembly 100, the conductor 102, and/or the strength member 110 as described with respect to FIG. 1. Accordingly, the encapsulation layers 614 and the traceability features 660 may be substantially similar to encapsulation layers 114, 214 and traceability features 160, 260 as previously described in FIG. 1, FIG. 2A, or FIG. 2B, respectively, and, therefore, certain features of the encapsulation layers 614 or traceability features 660 may not be described in further detail herein.

As shown in FIG. 6, the traceability features 660 include laser markings (e.g., laser engravings, laser etchings, etc.). The first traceability feature 660a, is formed via a laser having a laser power of 100 W. The second traceability feature 660b was formed via a laser having a laser power of 100 W. The third traceability feature 660c was formed via a laser having a laser power of 50 W. As shown in FIG. 6, each of the traceability features 660a, 660b, 660c are sufficiently visible on an outer surface of the corresponding encapsulation layers 614a, 614b, 614c when formed via lasers having laser powers of 50 W or 100 W. In some embodiments, the traceability features 660 may be formed via a laser having a laser power in a range of about 1 W to about 100 W, or greater, inclusive (e.g., 1 W, 10 W, 20 W, 30 W, 40 W, 50 W, 60 W, 70 W, 80 W, 90 W, 100 W, or greater, inclusive).

While the traceability features 660 in FIG. 6 are formed via a marking, laser etching, and/or laser engraving, in some embodiments, the traceability features 660 may be formed via mechanical engraving, intaglio printing, stamping, or a combination thereof. Likewise, in some embodiments, the traceability features 660 may include a marking, an etching, an engraving, a stamp, a print, an imprint, a scrape, a burn, or a combination thereof. For example, the traceability feature 660 may include a laser marking, a chemical etching, a printed mark, a stamp mark, and/or a burn mark. Such markings may be disposed on any surface of a strength member (e.g., the strength member 110 as described with respect to FIG. 1), for example, disposed on the outer surface of the encapsulation layer 114 at any suitable location.

As shown in FIG. 6, each of the encapsulation layers 614 are formed of aluminum. However, in some embodiments, the encapsulation layers 614 may include or be formed of aluminum (e.g., 1350-H19), annealed aluminum (e.g., 1350-0), aluminum alloys (e.g., Al-Zr alloys, 6000 series Al alloys such 6201-TSI, -T82, -T83, 7000 series Al alloys, 8000 series Al alloys, etc.), copper, copper alloys (e.g., copper magnesium alloys, copper tin alloys, copper micro-alloys, etc.), any other suitable conductive material, or any combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

As utilized herein, the terms “substantially’ and similar terms are intended to have a broad meaning in harmony with the common and accepted usage by those of ordinary skill in the art to which the subject matter of this disclosure pertains. For example, the term “substantially flat” would mean that there may be de minimis amount of surface variations or undulations present due to manufacturing variations present on an otherwise flat surface. It should be understood by those of skill in the art who review this disclosure that these terms are intended to allow a description of certain features described and claimed without restricting the scope of these features to the precise arrangements and/or numerical ranges provided. Accordingly, these terms should be interpreted as indicating that insubstantial or inconsequential modifications or alterations of the subject matter described and claimed are considered to be within the scope of the inventions as recited in the appended claims.

The terms “coupled,” and the like as used herein mean the joining of two members directly or indirectly to one another. Such joining may be stationary (e.g., permanent) or moveable (e.g., removable, or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes, and omissions may also be made in the design, operating conditions, and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. An apparatus, comprising:
a strength member, including:
a core formed of a composite material,
an encapsulation layer disposed around the core, and
a traceability feature incorporated in at least one of the core or the encapsulation layer; and
a conductor layer disposed around the strength member such that the traceability feature is disposed beneath the conductor layer.

2. The apparatus of claim 1, wherein the traceability feature is disposed on the encapsulation layer.

3. The apparatus of claim 2, wherein the encapsulation layer includes an inner surface and an outer surface, the traceability feature disposed on the outer surface of the encapsulation layer.

4. The apparatus of claim 3, wherein the traceability feature includes one or more grooves etched on the outer surface of the encapsulation layer.

5. The apparatus of claim 4, wherein the one or more grooves have a groove depth in a range of about 0.5 μm to about 500 μm.

6. The apparatus of claim 1, wherein the traceability feature is formed via at least one of laser marking, laser etching, laser engraving, mechanical engraving, intaglio printing, or stamping.

7. The apparatus of claim 1, wherein the traceability feature includes at least one of a barcode, a quick-response (QR) code, an alphanumeric character, a symbol, a radio-frequency identification (RFID) tag, or an image.

8. The apparatus of claim 7, wherein the traceability feature includes a temperature activated indicator configured to indicate a temperature of the strength member.

9. The apparatus of claim 1, wherein the traceability feature is disposed proximal to an axial end of the strength member.

10. The apparatus of claim 1, wherein:
the apparatus is an electrical conductor for power-grid applications.

11. A method, comprising:
disposing an encapsulation layer around a core formed of a composite material to form a strength member;
disposing a traceability feature on the strength member; and
disposing a conductor layer around the strength member such that the traceability feature is disposed beneath the conductor layer.

12. The method of claim 11, wherein the traceability feature is disposed on an outer surface of the encapsulation layer.

13. The method of claim 12, wherein disposing the traceability feature includes etching the traceability feature on the outer surface of the encapsulation layer via laser marking, laser etching, or laser engraving.

14. The method of claim 11, further comprising:
identifying the traceability feature through the conductor layer using radiative energy, the radiative energy configured to penetrate through the conductor layer to the traceability feature and to interact with the traceability feature to identify a characteristic of the traceability feature.

15. The method of claim 14, wherein the radiative energy includes X-rays, ultrasound waves, or infrared waves.

16. A system comprising:
a conductor including:
a strength member comprising:
a core formed of a composite material; and
an encapsulation layer disposed around the core; and
a conductor layer disposed around at least a portion of the strength member;
a support assembly coupled to an axial end of the conductor; and
a traceability feature coupled to at least one of the conductor or the support assembly.

17. The system of claim 16, wherein the support assembly includes at least one of a dead-end coupler, a splice coupler, or a suspension clamp.

18. The system of claim 17, wherein the traceability feature is coupled to the support assembly.

19. The system of claim 16, wherein the traceability feature includes a radio-frequency identification (RFID) tag.

20. The system of claim 19, wherein the RFID tag can be traced from a distance of up to about 30 meters.

21. The system of claim 16, wherein the traceability feature includes a temperature indicator coupled to the strength member, the temperature indicator configured to detect thermal exposure of the strength member during operation.

22. The system of claim 21, wherein the temperature indicator includes a temperature sensitive element configured to undergo a color change at a distinct temperature threshold.
